(19) United States
(12) Patent Application Publication
(10) Pub. No.: US 2024/0132721 A1
(43) Pub. Date: Apr. 25, 2024

(54) SILICONE-POLYOLEFIN HYBRID ELASTOMERS

(71) Applicants: DOW SILICONES CORPORATION, Midland, MI (US); DOW GLOBAL TECHNOLOGIES LLC, Midland, MI (US)

(72) Inventors: Dongchan AHN, Midland, MI (US); Noel Mower CHANG, Midland, MI (US); Alyssa FIELITZ, Midland, MI (US); Zachary KEAN, Midland, MI (US); Thomas H. PETERSON, Midland, MI (US); Peter WALLER, Midland, MI (US)

(21) Appl. No.: 18/276,441

(22) PCT Filed: Feb. 10, 2022
(86) PCT No.: PCT/US2022/015924

§ 371 Date: Aug. 8, 2023

Related U.S. Application Data
(60) Provisional application No. 63/147,893, filed on Feb. 10, 2021.

(51) Int. Cl. C08L 83/04

(52) U.S. Cl. CPC C08L 83/04

(57) ABSTRACT

A flowable silicone-polyolefin composition is disclosed. The silicone-polyolefin composition comprises (A) a polysiloxane and (B) a functionalized polyolefin dispersed in the polysiloxane (A). The polysiloxane (A) comprises an average per molecule of at least one functional group X, and the functionalized polyolefin (B) comprises an average per molecule of at least one functional group Y that is reactable with the functional group X of the polysiloxane (A) to form a bond therebetween. A curable composition comprising the flowable silicone-polyolefin composition, a cured product of the curable composition, and methods of preparing the flowable silicone-polyolefin composition, curable composition, and cured product are also disclosed.

### CROSS REFERENCE TO RELATED APPLICATIONS

This application claims priority to and all advantages of U.S. Provisional Patent Application No. 63/147,893 filed on 10 Feb. 2021, the content of which is incorporated herein by reference.

### FIELD OF THE INVENTION

The present disclosure relates generally to silicone compositions and, more specifically, to a flowable silicone-polyolefin composition and cured products and composite materials prepared therewith.

### DESCRIPTION OF THE RELATED ART

Silicones are polymeric materials used in numerous commercial applications, primarily due to significant advantages they possess over their carbon-based analogues. More particularly referred to as polymerized siloxanes or polysiloxanes, silicones include an inorganic silicon-oxygen backbone chain ( . . . —Si—O—Si—O—Si—O— . . . ) having organic side groups attached to the silicon atoms. Organic side groups may be used to link two or more of these backbones together. By varying the —Si—O— chain lengths, side groups, and cross-linking, silicones can be synthesized with a wide variety of properties and compositions, with silicone networks varying in consistency from liquid to gel to rubber to hard plastic. Silicone and siloxane-based materials are utilized in myriad end use applications and environments, including as components in a wide variety of industrial, home care, and personal care formulations.

The most common silicone materials are based on the linear organopolysiloxane polydimethylsiloxane (PDMS), a silicone oil, followed by those based on silicone resins formed with branched and cage-like oligosiloxanes. Many of these materials enable unique technologies by providing enhanced performance and benefits due to inherent attributes of organopolysiloxane, including low-loss and stable optical transmission capabilities, high thermal and oxidative stabilities, and biocompatibility.

Unfortunately, despite widespread success in numerous technologies, the use of -silicone materials in certain applications remains limited, if even practicable, due to less-desirable attributes of many conventional siloxanes, such as their weak mechanical properties, which may manifest in materials with poor or unsuitable characteristics such as low tensile strength, low tear strength, etc. As such, carbon-based polymers, such as those based on polyolefin, polyacrylate, and polyurethane resins, are frequently employed in applications that could otherwise benefit from particular inherent attributes of silicones. Complicating matters further, conventional siloxanes are incompatible with most carbon-based polymers, typically due to immiscibility and/or exhibiting antagonistic properties with respect to one another.

### BRIEF SUMMARY

A flowable silicone-polyolefin composition (the “flowable composition”) is provided. The flowable composition comprises (A) a polysiloxane comprising an average of at least one functional group X per molecule, and (B) a functionalized polyolefin dispersed in the polysiloxane (A). The functionalized polyolefin (B) comprises an average per molecule of at least one functional group Y that is reactable with the functional group X of the polysiloxane (A) to form a bond therebetween.

A method of preparing the flowable composition (the “preparation method”) is also provided. The preparation method comprises dispersing the functionalized polyolefin (B) in the polysiloxane (A), thereby preparing the flowable composition.

A curable composition is also provided. The curable composition comprises the flowable composition and a cure catalyst, filler, and/or a cross-linker.

A cured product of the curable composition, and a method of preparing the cured product, are also provided.

### DETAILED DESCRIPTION OF THE INVENTION

A flowable silicone-polyolefin composition (the “flowable composition”) is provided herein, along with a method of preparing the same (the “preparation method”). As will be understood from the description herein, the flowable composition provides a hybrid composition that contains both silicone and polyolefin components, and may be prepared and used without the aid of solvent. As silicone and polyolefin components are generally understood to be immiscible or otherwise incompatible with one another, the particular compounds and conditions utilized provide unique hybrid materials that exhibit desirable characteristics and properties that may be unobtainable with conventional methods and materials. Likewise, the flowable composition may be exploited as a platform for efficient and economical preparation of numerous functional compositions and components thereof, including in some applications that are poorly suited, if even practicable, for use with conventional materials. Indeed, a curable composition and cured product prepared therefrom, as well as methods of making the same, are also provided herein and illustrated in the examples below.

In view of this disclosure, one of skill in the art will readily appreciate that the unique structural and physical features of the inventive compositions are compatible with useful production techniques, such as melt-blending and reactive extrusion, without certain drawbacks inherent to using such techniques with traditional materials. Additionally, as also described and illustrated herein, the inventive compositions enable the preparation of products with enhanced performance characteristics, including injection moldable articles with improved toughness (e.g. increased tear strength) and chemical resistance (e.g. increased solvent swell resistance), satisfactory elongation and tensile strength, and desirable haptics. Such articles may be specifically employed in consumer articles, where specific performance characteristics provided by conventional materials are often mutually exclusive, and enhancing any one property may decrease the positive tactual experience of a user.

The flowable composition generally includes (A) a polysiloxane and (B) a functionalized polyolefin dispersed in the polysiloxane (A). The polysiloxane (A) comprises an average, per molecule, of at least one functional group X, and the functionalized polyolefin (B) comprises an average, per molecule, of at least one functional group Y that is reactable with the functional group X of the polysiloxane (A) to form a bond therebetween. As will be appreciated from the description below, the polysiloxane (A) may comprise an average of at least two, or more, functional groups X per molecule, and the functionalized polyolefin (B) may comprise an average of at least two, or more, functional groups Y per molecule

By “flowable”, it is meant that the flowable composition is flowable at 25° C. and/or has a viscosity that is measurable at 25° C. In certain embodiments, the flowable composition is flowable in the absence of any solvent, e.g. organic solvent. Typically, the flowable composition is flowable even when the flowable composition consists essentially of, alternatively consists of, components (A) and (B). Said differently, components (A) and (B) together are typically flowable. In these or other embodiments, the viscosity of the flowable composition is measurable at 25° C. via a Brookfield LV DV-E viscometer with a spindle selected as appropriate to the viscosity of the of the flowable composition; alternatively (or additionally), parallel plate geometry may be utilized. The viscosity of the flowable composition may vary, particularly based on the selection of components (A) and (B) and their relative amounts, as described below. However, for purposes of this disclosure, the flowable composition can be in the form of a gum, as gums still have flowable characteristics, even if gums do not have viscosities that can be readily measured at 25° C. The flowable composition need not be a gum, however, such that, in other embodiments, the flowable composition is a liquid and not a gum. In these or other embodiments, the flowable composition may be flowable based on the presence of other components along with components (A) and (B), e.g. liquid silicone rubber(s), diluents, organic solvents, etc.

The polysiloxane (A) and the functionalized polyolefin (B), which are described in turn below, along with additional compounds that may be present in the flowable composition which may be collectively referred to herein as the “components” of the flowable composition (i.e., “component (A)”, “component (B)”, etc., respectively.) or, likewise, as “compound(s),” and/or “reagent(s)” (A) and/or (B), etc.

As introduced above, the flowable composition comprises the polysiloxane (A). As understood by those of skill in the art, polysiloxanes are silicon-based compounds comprising a siloxane backbone, i.e., an at least semi-contiguous chain composed of inorganic silicon-oxygen-silicon groups (i.e., —Si—O—Si—), with organosilicon and/or organic side groups attached to the silicon atoms. Such siloxanes are typically characterized in terms of the number, type, and/or proportion of [M], [D], [T], and/or [Q] units/siloxy groups, which each represent structural units of individual functionality present in polysiloxanes, such as organosiloxanes and organopolysiloxanes. In particular, [M] represents a monofunctional unit of general formula R″₃SiO_{1/2}; [D] represents a difunctional unit of general formula R″₂SiO_{2/2}; [T] represents a trifunctional unit of general formula R″SiO_{3/2}; and [Q] represents a tetrafunctional unit of general formula SiO_{4/2}, as shown by the general structural moieties below:

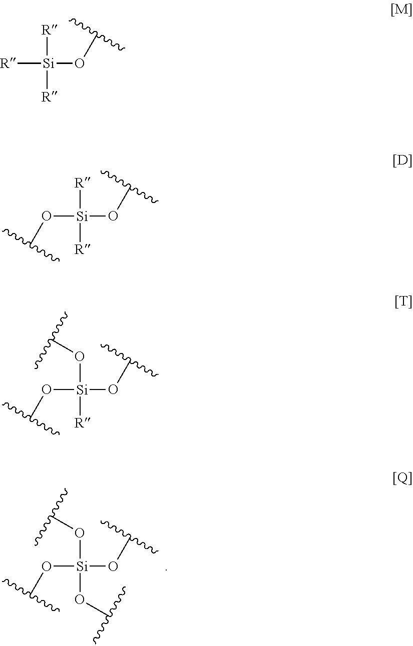

In these general structural moieties, each R″ is independently a monovalent or polyvalent substituent. As understood in the art, specific substituents suitable for each R″ are not particularly limited (e.g. may be monoatomic or polyatomic, organic or inorganic, linear or branched, substituted or unsubstituted, aromatic, aliphatic, saturated or unsaturated, etc., as well as various combinations thereof). In typical examples, each R″ is independently selected from hydrocarbyl groups, alkoxy and/or aryloxy groups, and siloxy groups. With regard to hydrocarbyl groups suitable for R″, examples generally include monovalent hydrocarbon moieties, as well as derivatives and modifications thereof, which may independently be substituted or unsubstituted, linear, branched, cyclic, or combinations thereof, and saturated or unsaturated. With regard to such hydrocarbyl groups, the term “unsubstituted” describes hydrocarbon moieties composed of carbon and hydrogen atoms, i.e., without heteroatom substituents. The term “substituted” describes hydrocarbon moieties where either at least one hydrogen atom is replaced with an atom or group other than hydrogen (e.g. a halogen atom, an alkoxy group, an amine group, etc.) (i.e., as a pendant or terminal substituent), a carbon atom within a chain/backbone of the hydrocarbon is replaced with an atom other than carbon (e.g. a heteroatom, such as oxygen, sulfur, nitrogen, etc.) (i.e., as a part of the chain/backbone), or both. As such, suitable hydrocarbyl groups may comprise, or be, a hydrocarbon moiety having one or more substituents in and/or on (i.e., appended to and/or integral with) a carbon chain/backbone thereof, such that the hydrocarbon moiety may comprise, or otherwise be referred to as, an ether, an ester, etc. Linear and branched hydrocarbyl groups may independently be saturated or unsaturated and, when unsaturated, may be conjugated or nonconjugated. Cyclic hydrocarbyl groups may independently be monocyclic or polycyclic, and encompass cycloalkyl groups, aryl groups, and heterocycles, which may be aromatic, saturated and nonaromatic and/or non-conjugated, etc. Examples of combinations of linear and cyclic hydrocarbyl groups include alkaryl groups, aralkyl groups, etc. General examples of hydrocarbon moieties suitably for use in or as the hydrocarbyl group include alkyl groups, aryl groups, alkenyl groups, alkynyl groups, halocarbon groups, and the like, as well as derivatives, modifications, and combinations thereof. Examples of alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, and the like (i.e., other linear or branched saturated hydrocarbon groups, e.g. having greater than 6 carbon atoms). Examples of aryl groups include phenyl, tolyl, xylyl, naphthyl, benzyl, dimethyl phenyl, and the like, as well as derivatives and modifications thereof, which may overlap with alkaryl groups (e.g. benzyl) and aralkyl groups (e.g. tolyl, dimethyl phenyl, etc.). Examples of alkenyl groups include vinyl, allyl, propenyl, isopropenyl, butenyl, isobutenyl, pentenyl, heptenyl, hexenyl, cyclohexenyl groups, and the like, as well as derivatives and modifications thereof. General examples of halocarbon groups include halogenated derivatives of the hydrocarbon moieties above, such as halogenated alkyl groups (e.g. any of the alkyl groups described above, where one or more hydrogen atoms is replaced with a halogen atom such as F or Cl), aryl groups (e.g. any of the aryl groups described above, where one or more hydrogen atoms is replaced with a halogen atom such as F or Cl), and combinations thereof. Examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, 3,4-difluoro-5-methylcycloheptyl, chloromethyl, chloropropyl, 2-dichlorocyclopropyl, 2,3-dichlorocyclopentyl, and the like, as well as derivatives and modifications thereof. Examples of halogenated aryl groups include chlorobenzyl, pentafluorophenyl, fluorobenzyl groups, and the like, as well as derivatives and modifications thereof. With regard to alkoxy and/or aryloxy groups suitable for R″, examples generally include hydrocarbyl (e.g. alkyl, aryl, etc.) groups bonded to the silicon atom via an oxygen atom (i.e., forming a silyl ether). The hydrocarbyl groups in these examples may include any of the hydrocarbyl groups described above. With regard to siloxy groups suitable for R″, examples generally include siloxy groups represented by any one, or combination, of [M], [D], [T], and/or [Q] units described above.

One of skill in the art understands how [M], [D], [T] and [Q] units, and their relative proportions (i.e., molar fractions) influence and control the structure of siloxanes, and that polysiloxanes in general may be monomeric, polymeric, oligomeric, linear, branched, cyclic, and/or resinous depending on the selection of [M], [D], [T] and/or [Q] units therein. For example, [T] units and/or [Q] units are typically present in siloxane resins, whereas siloxane polymers (e.g. silicones) are typically free from such [T] units and/or [Q] units. [D] units are typically present in both siloxane resins and polymers. One of skill in the art will also appreciate that siloxanes may be named based on the type and proportion of such siloxy units. For example, the siloxane resins referenced above may be characterized as DT resins, MQ resins, MDQ resins, etc. Likewise, siloxanes that are substantially free from branching attributable to [T] units and/or [Q] units are typically referred to as “linear”. However, it will be appreciated that a linear (i.e., MDM-type) siloxane may comprise individual molecules having T and/or Q units and still be considered “linear” based on the average unit formula of the siloxane as a whole.

In general, the polysiloxane (A) comprises a polydiorganosiloxane-containing backbone having at least one, alternatively at least two functional groups X per molecule. Typically, the polysiloxane (A) is substantially linear, alternatively is linear. In such instances, one of skill in the art will appreciate that the polysiloxane (A) is typically free from [T] siloxy units and/or [Q] siloxy units, as described above.

In some embodiments, the polysiloxane (A) has the following general formula:

[XₘR¹₃₋ₘSiO_{1/2}]ₐ[XₙR¹₂₋ₙSiO_{2/2}]_{b},

where each X is a functional group as introduced above, each R¹ is an independently selected hydrocarbyl group, subscript m is independently 1 or 0 in each moiety indicated by subscript a, subscript n is independently 1 or 0 in each moiety indicated by subscript b, and subscripts a and b are mole fractions such that a+b=1, with the provisos that 0<a<1, 0<b<1, and the polysiloxane (A) comprises at least one, alternatively at least two functional groups X.

With reference to the general unit formula of the polysiloxane (A) above, hydrocarbyl groups suitable for R¹ are generally exemplified by those described above. Typically, each R¹ is a substituted or unsubstituted hydrocarbyl group having from 1 to 30 carbon atoms. For example, in some embodiments, each R¹ is an independently selected hydrocarbyl group having from 1 to 12, alternatively from 1 to 8, alternatively from 1 to 6, carbon atoms. In some such embodiments, each R¹ is further defined as an alkyl group, aryl group, or combination thereof. For example, in some embodiments, R¹ represents an independently selected substituted or unsubstituted alkyl group. Specific examples of such alkyl groups include methyl groups, ethyl groups, propyl groups (e.g. n-propyl and iso-propyl groups), butyl groups (e.g. n-butyl, sec-butyl, iso-butyl, and tert-butyl groups), pentyl groups, hexyl groups, etc., and the like, as well as derivatives and/or modifications thereof. Examples of derivatives and/or modifications of such alkyl groups include substituted versions thereof, e.g. where a hydroxyl ethyl group will be understood to be a derivative and/or a modification of the ethyl groups described above.

Each R¹ may be the same as or different from any other R¹ of the polysiloxane (A). In certain embodiments, each R¹ is the same as each other R¹ of the polysiloxane (A). For example, in some such embodiments, each R¹ is methyl. In other embodiments, at least one R¹ is different from at least one other R¹ of the polysiloxane (A). For example, in certain embodiments, R¹ is predominantly methyl throughout the polysiloxane (A), with one or more other groups pending from the polydiorganosiloxane backbone in minor amounts (e.g. from the preparation of the polysiloxane (A), environmental reactions or impurities, etc.). In some embodiments, one or more, alternatively each, R¹ is a fluoroalkyl group, i.e. such that the polysiloxane (A) may be further defined or referred to as a fluorosilicone or fluoropolysiloxane.

As introduced above, the polysiloxane (A) comprises, on average, at least one functional group per molecule, as represented by moiety X in the general formula of the polysiloxane (A) above. In some embodiments, however, the polysiloxane (A) comprise an average of at least two functional groups X per molecule.

As described in herein, the functional groups X of the polysiloxane (A) are reactable with the functional groups Y of the functionalized polyolefin (B) to form a bond therebetween. In other words, one functional group X and one functional group Y are capable of reacting together (i.e., via a coupling reaction, cross-linking reaction, etc.), to covalently bond together the polysiloxane (A) and the functionalized polyolefin (B). It is to be understood that terms such as “coupling,” “coupleable,” “reactable,” “cross-linking,” and “cross-linkable” used herein are not intended to imply any directionality to a reaction, but instead will be understood in the customary sense to refer to the coupling facilitated by groups X and Y without inference as to particular reactivity or role in the reaction therebetween. As described herein, in some embodiments, the average molecules of components (A) and/or (B) have at least two groups capable of participating in the coupling reaction, such that a single molecule of the polysiloxane (A) may be, on average, capable of being coupled at least once to two or more molecules of the functionalized polyolefin (B) or, likewise, at least twice to a single molecule of the functionalized polyolefin (B).

In general, each functional group X comprises, alternatively is, a functional group that may participate in the cross-linking reaction described above. Examples of such functional groups are typically reactive via substitution reaction, addition reaction, coupling reaction, or combinations thereof. Specific examples of such reactions include nucleophilic substitutions, ring-opening additions, alkoxylations and/or transalkoxylations, hydrosilylations, olefin metatheses, condensations, radical couplings and/or polymerizations, and the like, as well as combinations thereof. Accordingly, functional groups may comprise, or be, a functional group that is hydrosilylatable (e.g. a silicon-bonded hydrogen atom, an ethylenically unsaturated group such as an alkenyl group, alkynyl group, etc.), condensable (e.g. a hydroxyl group, a carboxyl group, an alkoxysilyl group, a silanol group, a carbinol group, an amide group, etc., or a group that may be hydrolyzable and subsequently condensable), displaceable (e.g. a “leaving group” as understood in the art, such as a halogen atom, or other group stable in an ionic form once displaced, or a functional group comprising such a leaving group, such as esters, anhydrides, amides, epoxides, etc.), nucleophilic (e.g. a heteroatom with lone pairs, an anionic or anionizable group, etc., such as a hydroxyl group, an amine group, a thiol group, a silanol group, a carboxylic acid group, etc.), electrophilic (e.g. isocyanates, epoxides, etc.), or various combinations thereof.

Typically, the polysiloxane (A) and the functionalized polyolefin (B) are coupleable via hydrosilylation reaction or condensation reaction. As such, in certain embodiments, each functional group X of the polysiloxane (A) is selected from hydrosilylatable groups and condensable groups.

In some embodiments, at least one, alternatively at least two, alternatively each functional group X is a hydrosilylatable group, and thus selected from olefinically-unsaturated groups (e.g. ethylenically unsaturated groups) and H. In some such embodiments, each hydrosilylatable group represented by X is H, such that the polysiloxane (A) is silicon hydride-functional. In other of such embodiments, each hydrosilylatable group represented by X is an ethylenically unsaturated group.

Examples of ethylenically unsaturated groups generally include substituted or unsubstituted hydrocarbon groups having at least one alkene or alkyne functional group. For example, in certain embodiments, each functional group X comprises, alternatively is, an alkenyl group or an alkynyl group. Specific examples thereof include H₂C═CH—, H₂C═CHCH₂—, H₂C═CHCH₂CH₂—, H₂C═CH(CH₂)₃—, H₂C═CH(CH₂)₄—, H₂C═C(CH₃)—, H₂C═C(CH₃)CH₂—, H₂C═C(CH₃)CH₂CH₂—, H₂C═C(CH₃)CH₂CH(CH₃)—, H₂C═C(CH₃)CH(CH₃)CH₂—, H₂C═C(CH₃)C(CH₃)₂—, HC≡C—, HC≡CCH₂—, HC≡CCH(CH₃)—, HC≡CC(CH₃)₂—, and HC≡CC(CH₃)₂CH₂—. In specific embodiments, each functional group X comprises, alternatively is, a vinyl group.

In embodiments where the functional group X comprises one of the ethylenically unsaturated groups above, it will be appreciated that the functional group X may also comprise a divalent linking group between the ethylenically unsaturated group and a silicon atom of the polysiloxane (A). Examples of such divalent linking groups include divalent versions of the hydrocarbyl groups described above, such as alkyl groups. For example, the functional group X may have the formula H₂C═CH—(CH₂)₅—, which may be considered to represent the alkenyl group H₂C═CHCH₂— with a butylene linking group, the alkenyl group H₂C═CH(CH₂)₄— with a methylene linking group, etc. In certain embodiments, each functional group X comprises, alternatively is a methacryloxy group, such as a silicon-bonded methacryloxyalkyl group.

In some embodiments, at least one, alternatively at least two, alternatively each functional group X comprises, alternatively is, a condensable group, i.e., is capable of participating in a condensation reaction. In specific embodiments, each functional group X comprises a condensable group selected from anhydride groups and amine groups.

Examples of suitable anhydrides for functional group X generally include anhydrides of monocarboxylic acids (e.g. acetic acid, lactic acid, propanoic acid, pentanoic acid, methacrylic acid, etc.), which may be homoan hydrides or mixed anhydrides, as well as polycarboxylic acids such as succinates (i.e., succinic anhydrides), maleates (i.e., maleic anhydrides), phthalates, etc. One of skill in the art will appreciate that various substitution patterns are possible with such anhydrides in terms of linking the same to the silicon atom of the polysiloxane (A). Typically, such anhydrides may be grafted onto a siloxane polymer to prepare the polysiloxane (A), and thus one of skill in the art will understand the applicability of other anhydrides, and carboxylic acids/carboxylates that may also be utilized, e.g. via grafting directly to the polysiloxane (A) or instead via an initial grafting and subsequent reaction to prepare the anhydride. For example, anhydrides containing at least one olefinically unsaturated group, such as alkenylsuccinic anhydrides, bromomaleic anhydride, chloromaleic anhydride, citraconic anhydride, methylnadic anhydride, nadic anhydride, tetrahydrophthalic anhydride, and the like, may be grafted onto a siloxane (e.g. via hydrosilylation). Free radical based grafting schemes may also be used to produce anhydride functional siloxanes from reagents such as maleic anhydride and vinylsiloxanes.

Examples of suitable amines for functional group X generally include primary amino-substituted derivatives of the hydrocarbyl groups described above. For example, functional group X may comprise, alternatively may be, an aminoalkyl group, such as an amino-substituted alkyl group having from 1 to 20 carbon atoms (e.g. aminomethyl, 2-aminoethyl, 3-aminopropyl, 6-aminohexyl, an aminoaryl group (e.g. 4-aminophenyl, 3-(4-aminophenyl) propyl, etc.), or an aminoalkylamino group (e.g. N-(2-aminoethyl)-3-aminopropyl, N-(2-aminoethyl)-3-aminoisobutyl, etc.).

With reference to the general unit formula of the polysiloxane (A) above, subscript m is independently 1 or 0 in each moiety indicated by subscript a, subscript n is independently 1 or 0 in each moiety indicated by subscript b. As such, subscripts m and n merely indicate the presence of the functional group X in any particular [M] unit (i.e., as indicated by subscript a) or [D] unit (i.e., as indicated by subscript b). When each subscript m is 0 (i.e., subscript m is 0 in each moiety indicated by subscript a), the polysiloxane (A) comprises at least one pendant functional X (i.e., bonded to a [D] unit). When each subscript n is 0 (i.e., subscript n is 0 in each moiety indicated by subscript b), the polysiloxane (A) comprises at least one terminal functional X (i.e., bonded to an [M] unit). In some embodiments, the polysiloxane (A) is only terminally-functional with respect to the functional groups X, such that subscript n is 0 in each moiety indicated by subscript b. In some such embodiments, the polysiloxane (A) comprises at least two moieties indicated by subscript a, and subscript m is 1 in at least two moieties indicated by subscript a. In other embodiments, the polysiloxane (A) comprises at least one terminal functional group X. In yet other embodiments, the polysiloxane (A) comprises only pendant functionality with respect to the functional groups X, such that subscript m is 0 in each moiety indicated by subscript a, the polysiloxane (A) comprises at least two moieties indicated by subscript b, and subscript n is 1 in at least two moieties indicated by subscript b.

With continued reference to the general unit formula of the polysiloxane (A) above, subscripts a and b are each mole fractions such that a+b=1, with the provisos that 0<a<1 and 0<b<1. It will be appreciated that the moieties indicated by subscripts a and b are generally [M] and [D] siloxy units, respectively. As such, in certain embodiments, the polysiloxane (A) may be defined as an MDM-type polysiloxane. Accordingly, in such embodiments, the polysiloxane (A) may be defined as a linear polysiloxane (or, more simply, “linear siloxane”). Nonetheless, it is to be appreciated that the general formula above may be an average unit formula, i.e., the average formula based on all molecules in the polysiloxane (A). As such, as described above with regard to siloxanes generally, the polysiloxane (A) may comprise a limited amount of branching (e.g. attributable to [T] and/or [Q] units) without departing from the scope of linearity understood by those of skill in the art, even though such units are not included in the general unit formula above. Typically, the polysiloxane (A) is substantially free from, alternatively free from, [T] and/or [Q] units.

In some embodiments, each of the units represented by subscripts a and b are independently selected, and at least two units of the polysiloxane (A) comprise the functional group X. In such embodiments, the preceding general formula for the polysiloxane (A) may be rewritten as the following expanded average unit formula:

[XR¹₂SiO_{1/2}]_{a′}[XR¹SiO_{2/2}]_{b′}[R¹₂SiO_{2/2}]_{b″}[R¹₃SiO_{1/2}]_{a″},

where each X and R¹ are as defined above, subscripts a′, a″, b′, and b″ each indicate the number of corresponding moieties are present in the polysiloxane (A). In this fashion, a′+a″ is equal to number of [M] siloxy units present in the mole fraction represented by subscript a in the general formula above, and b′+b″ is equal to number of [D] siloxy units present in the mole fraction represented by subscript b in the general formula above. For example, in general, a′+a″2, a′+b′ 2, and b′+b″ 1. In the specific embodiments described above, where the polysiloxane (A) is only terminally functional, a′=2, b′=0, b″ 1, and a″=0.

In some embodiments, the polysiloxane (A) has a number average degree of polymerization (DP) of from 10 to 10,000. As such, with reference to the preceding expanded formula of the polysiloxane (A), a′+a″+b′+b″ is generally from 10 to 10,000. For example, in some embodiments, the polysiloxane (A) has a DP of 10 to 5,000, such as from 10 to 1200, alternatively from 50 to 1200, alternatively from 100 to 1200, alternatively from 100 to 1100, alternatively from 200 to 1100. In specific embodiments, a′ and a″ are each from 0 to 2, typically with a′+a″=2. Subscript b″ may be from 0 to 10,000, such as from 10 to 5,000, alternatively from 10 to 1200, alternatively from 100 to 1200, alternatively from 200 to 1100. In these or other embodiments, subscript b′ is from 0 to 100, such as from 0 to 50, alternatively from 0 to 25, alternatively from 0 to 10, alternatively from 0 to 5, alternatively from 0 to 2. In specific embodiments, subscript b′ is 0 and subscript b″ is from 200 to 1200, alternatively from 200 to 1000, alternatively from 400 to 1000.

In certain embodiments, the polysiloxane (A) has a degree of substitution (DS) of from 1 to 200. It will be appreciated that the DS of the polysiloxane (A) may be represented by the sum of subscripts a′ and b′ in the expanded formula above, i.e., which indicates the number of functional groups X. In some embodiments, the polysiloxane (A) has a DS of from 1 to 100, alternatively from 1 to 50, alternatively from 1 to 20, alternatively from 1 to 10, alternatively from 2 to 10.

In some embodiments, the polysiloxane (A) comprises a molecular weight distribution, as represented by polydispersity index (PDI) (i.e., the weight average molecular weight/number average molecular weight (Mw/Mn), of less than 3, alternatively less than 2.5, alternatively less than 2.25, and at the same time greater than or equal to 1. For example, the polysiloxane (A) may comprise a PDI of from 1 to 3, such as from 1 to 2.5, alternatively from 1.5 to 2.5, alternatively from 1.5 to 2.2, alternatively from 1.8 to 2.2, alternatively of about 2. Methods of determining the PDI for the polysiloxane (A) are known in the art, and generally include weight determinations via rheology, solution viscosity, gel permeation chromatography (GPC), etc., with standards and procedures readily understood and available.

Typically, the polysiloxane (A) utilized in the flowable composition is itself flowable, i.e., comprises a viscosity low enough to exhibit flow under ambient conditions (e.g. at 25° C.). For example, in certain embodiments, the polysiloxane (A) comprises a viscosity of from 10 to 1,000,000 mPa-s, such as from 10 to 500,000, alternatively from 10 to 250,000, alternatively from 10 to 100,000, alternatively from 1000 to 100,000, alternatively from 5000 to 100,000 mPa-s at 25° C. (e.g. as determined via viscometer, such as a Brookfield LV DV-E viscometer equipped with an appropriate spindle).

In certain embodiments, the polysiloxane (A) is further defined as a functionalized polydimethylsiloxane (PDMS), i.e., where each R¹ is methyl. In some such embodiments, the polysiloxane (A) is selected from amine-functional PDMS (i.e., where each functional group X comprises an amine, such as a primary aminoalkyl group) and vinyl-functional PDMS (i.e., where each functional group X comprises, alternatively is, a vinyl group).

In view of the description above, examples of such amine-functionalized PDMS suitable for use in, or as, the polysiloxane (A) will be understood to include terminal and/or pendant amine-functional PDMS oligomers and polymers. However, it will also be understood that, in certain embodiments, the polysiloxane (A) may comprise, alternatively may be, a terminal and/or pendant amine-functional random, graft, or block copolymer or co-oligomer of PDMS and a non-reactive siloxane (e.g. a polyphenylmethylsiloxane, a tris(trifluoropropyl)methylsiloxane, etc.). In this same fashion, examples of vinyl-functionalized PDMS suitable for use in, or as, the polysiloxane (A) include terminal and/or pendant vinyl-functional PDMS oligomers and polymers, as well as random, graft, or block copolymer or co-oligomer of PDMS and a non-reactive. In specific embodiments, the polysiloxane (A) comprises, alternatively is, an aminoalkyl-terminated PDMS, such as an α,ω-aminopropyl-terminated PDMS. In certain embodiments, the polysiloxane (A) comprises, alternatively is, a vinyl-terminated PDMS, such as an α,ω-vinyl-terminated PDMS.

As introduced above, the flowable composition also comprises the functionalized polyolefin (B). The functionalized polyolefin (B) comprises an average of at least one functional group Y per molecule, e.g. as a substituent of a polyolefin backbone. In some embodiments, the functionalized polyolefin (B) comprises an average of at least two functional group Y per molecule. As described herein, the functional groups Y are reactable with the functional groups X of the polysiloxane (A) to form a bond therebetween. As such, it will be understood that component (B) of the flowable composition generally comprises a polyolefin that is prepared with, obtained with, or otherwise functionalized to include the functional groups Y as substituents. Accordingly, the functionalized polyolefin (B) may comprise, alternatively may be, a terminally-substituted (i.e., a functional group-terminated) polyolefin, a pendantly-substituted polyolefin, or a combination thereof.

In general, polyolefins suitable for the functionalized polyolefin (B) are exemplified by polymers prepared from olefinic monomers, olefinic macromonomer and oligomers, and combinations thereof. Regardless of the actual synthetic route by which the functionalized polyolefin (B) is prepared, one of skill in the art will readily appreciate the scope of the polyolefin component of the functionalized polyolefin (B) in terms of its constituent parts (or theoretical constituent parts), i.e., the olefinic base monomers polymerized to prepare the polyolefin. The term “olefinic” used in the context of the base monomers composing the functionalized polyolefin (B) refers to the presence of an ethylenically unsaturated end group, i.e., which is polymerizable with an ethylenically unsaturated group of other olefinic monomer to provide a polyolefin. In this fashion, it will be understood that a “polyethylene” is a polyolefin derived, or theoretically derivable, from the monomer ethene (ethylene), which is the smallest ethylenically unsaturated compound. Likewise, a polyethylene-methacrylate copolymer is a polyolefin derived, or theoretically derivable, from the comonomers ethylene and methacrylate, with the latter monomer comprising a terminal ethylenically unsaturated group, i.e., an alpha-olefin (e.g. —C═CH₂). As such, it will be appreciated that, in typical embodiments, the functionalized polyolefin (B) comprises a poly-alpha-olefin backbone.

The poly-alpha-olefin backbone of the functionalized polyolefin (B) is not particularly limited, and generally comprises monomeric units derived, or at least theoretically derivable from, an alpha olefin having the general formula R²₂C═CH₂, where each R² is hydrogen or a hydrocarbyl group (i.e., a substituted or unsubstituted hydrocarbyl group), such as any of those described above. For example, in certain embodiments one R² is methyl and the other R² is an esteric carbon, such that the alpha olefin is a methacrylate (e.g. a methyl or ethyl methacrylate, where the other R² is a methyl ester or ethyl ester, respectively). In some embodiments, at least one R² is hydrogen and the alpha olefin has the general formula R²CH═CH₂, where R² is selected from hydrogen and linear or branched hydrocarbyl groups having from 1 to 12, alternatively from 1 to 8, alternatively from 1 to 6, alternatively 1 or 2, carbon atoms. Such hydrocarbyl groups may be substituted or unsubstituted, and are exemplified above with regard to the appropriate descriptions of hydrocarbyl groups for R″ and R¹. It will be appreciated, however, that oligomers of such alpha olefins may also be utilized in the preparation of the poly-alpha-olefin backbone. For example, polyethylene (PE) oligomers may be utilized to prepare a polyethylene polymer, which may also be prepared using ethene as the sole monomer. Likewise, polyethylene (PE) and polypropylene (PP) oligomers may be copolymerized to prepare a polyethylene-polypropylene (PE-PP) copolymer, such as a PE-PP block copolymer. Examples of other oligomers that may be used to prepare poly-alpha-olefin backbone of the functionalized polyolefin (B) include polypropylene oligomers, polybutylene oligomers, polyisobutylene oligomers, polyisoprene oligomers, polybutadiene oligomers, as well as combinations thereof, such as polyethylene/polypropylene oligomers and copolymers, polyethylene/polybutylene oligomers and copolymers, poly(ethylene/butylene)-polyisoprene oligomers and copolymers, etc.

In certain embodiments, the functionalized polyolefin (B) comprises a poly-alpha-olefin backbone comprising monomeric units selected from ethylene, propylene, butylene, and 2-methyl-propylene (i.e., isobutylene). In these or other embodiments, the poly-alpha-olefin backbone comprises monomeric units derived (or theoretically derivable) from alpha-olefins exemplified by hexene, heptene, octene, styrene, an acrylate or methacrylate compound (e.g. acrylic acid, methacrylic acid, acrylonitrile, methacrylonitrile, an acrylic or methacrylic ester such as a C₁-C₁₂ alkyl ester of acrylic or methacrylic acid, etc.), dienes such as butadiene, etc., or combinations thereof. Accordingly, it will be appreciated that the functionalized polyolefin (B) may comprise, alternatively may be, a homopolymer (i.e., having but one type of monomeric unit, or prepared from but one monomer or oligomers of but one monomer) or an interpolymer (i.e., having at least two different monomeric subunits, typically prepared from at least two monomers or oligomers comprising two or more monomeric subunits). It will be understood that the term “interpolymer” encompasses copolymers and terpolymers, i.e., polymers comprising two, or three, different monomeric units, respectively, as well as polymers prepared from four, five, six, or more monomers.

In particular embodiments, the functionalized polyolefin (B) comprises a functionalized polyethylene, polypropylene, or polyethylene-alpha olefin copolymer. In some such embodiments, the polyethylene-alpha olefin copolymer is selected from copolymers and terpolymers comprising polyethylene and at least one of polypropylene and polybutylene. Various forms of such polyolefins may also be utilized. For example, polyethylenes may be high density (HDPE, ρ≥13.941 g/cm³), medium density (MDPE, ρ=0.926-0.940 g/cm³), low density, (LDPE, ρ=0.910-0.940 g/cm³) or ultra-low density (ULDPE, ρ≤0.880 g/cm³), and variations thereof, such as linear-low density polyethylene (LLDPE, ρ=0.915-0.925 g/cm³). While such polyethylenes are distinguished from one another by density, one of skill in the art will appreciate that various other physical characteristics of such variants differ as well, and may be selected to impart particular properties on the silicone-polyolefin composition, as well as the curable composition and cured products that may be prepared therefrom.

As introduced above, the functionalized polyolefin (B) comprises an average of at least one, alternatively at least two functional groups Y per molecule. For purposes of illustration, the functionalized polyolefin (B) may be represented by the general formula L(-Y)_{c}, where L is the polyolefin backbone, each Y is a functional group as introduced above, and subscript c≥1. It will be appreciated that each functional group Y may be independently selected in each moiety indicated by subscript c, which is at least one, alternatively at least two, but may theoretically be much larger, as will be understood in view of the description of the degree of substitution of the functionalized polyolefin (B. Moreover, the location of each functional group Y along the polyolefin backbone L is not particularly limited, such that any functional group Y may represent a terminal or pendant group.

In some embodiments, the functionalized polyolefin (B) comprises the following general unit formula:

R⁴[CH₂C(R³)(Y)]_{d}[CH₂CH(R³)]ₑR⁴

where each Y is an independently selected functional group as introduced above, each R³ is independently selected from H and substituted and unsubstituted hydrocarbyl groups, each R⁴ is an independently selected terminal group, and subscripts d and e are each mole fractions such that d+e=1, with the provisos that 0<d<1, 0<e<1, the functionalized polyolefin (B) comprises at least one, alternatively at least two functional groups Y, and the moieties indicated by subscripts d and e may be in any order in the functionalized polyolefin (B).

With reference to the general unit formula of the functionalized polyolefin (B) above, one of skill in the art will appreciate that the group R³ is generally selected or otherwise controlled based on the particular alpha-olefin monomers used to prepare the functionalized polyolefin (B), or at least the backbone thereof. For example, where the functionalized polyolefin (B) is a functionalized polypropylene, R³ is methyl in each moiety indicated by subscript k. In such instances, the nature of R³ in the moieties indicated by subscript j will depend on how the functionalized polyolefin (B) was prepared. In particular, where such a functionalized polyethylene is a copolymer prepared from polypropylene and an alpha olefin comprising group Y, R³ will be H in each moiety indicated by subscript o (as opposed to the methyl groups R³ in the moieties indicated by subscript p). On the other hand, where such a functionalized polypropylene is a polypropylene homopolymer grafted with functional groups Y (e.g. via radial mediated grafting), R³ will typically be a methyl group throughout the functionalized polyolefin (B). As such, it will be appreciated that any R³ may be selected such that any one moiety indicated by subscript e may reflect a polymerization product of any of the alpha-olefin monomers described herein or, alternatively, a grafting-functionalization onto a polymer prepared from such alpha-olefins.

In view of the above, it will be appreciated that each R³ may be the same as or different from any other R³ of the functionalized polyolefin (B). In certain embodiments, each R³ is the same as each other R³ of the functionalized polyolefin (B). For example, in some such embodiments, each R³ is methyl. In other embodiments, at least one R³ is different from at least one other R³ of the functionalized polyolefin (B). For example, in certain embodiments, R³ is predominantly hydrogen throughout the functionalized polyolefin (B) (i.e., from ethene monomer), with a minor proportion of R³ being selected from alkyl groups (i.e., from propene or higher-order alpha-olefin monomer).

As introduced above, each R⁴ is an independently selected terminal group. More specifically, each R⁴ generally represents a terminally reacted monomer from the polymerization of the functionalized polyolefin (B), the byproduct of polymerization (i.e., from a radial initiation, propagation, and/or termination step, etc.), or simply a hydrogen atom. One of skill in the art will appreciate that the R⁴ is thus not particularly limited, will generally be selected by virtue of the route by which the functionalized polyolefin (B), and is typically present in the functionalized polyolefin (B) in such minor amounts as to not substantively impact the average unit formula indicated by subscripts d and e. As such, it is to be understood that R⁴ generally represents an unreactive group with regard to the compositions and methods provided herein.

As introduced above, the functionalized polyolefin (B) comprises at least one, alternatively at least two functional groups per molecule, which are represented by moiety Y in the general unit formula of the functionalized polyolefin (B) above. In general, the functional groups Y are selected based on the functional group X of the polysiloxane (A), such that the functionalized polyolefin (B) is reactive with the polysiloxane (A) in a coupling reaction involving functional group X and functional group Y. More specifically, as introduced above, the functional groups Y of the functionalized polyolefin (B) is reactable with the functional group X of the polysiloxane (A) to form a bond therebetween. In other words, one functional group Y and one functional group X are capable of reacting together (i.e., via additive coupling/cross-linking reaction), to covalently bond together the functionalized polyolefin (B) and the polysiloxane (A).

Accordingly, each functional group Y comprises a functional group that may participate in the coupling/cross-linking reaction described above, such as a functional group reactive via substitution reaction, addition reaction, coupling reaction, or combinations thereof, as well as any of the specific variants described above with respect to the functional groups X. Specific examples of such reactions include nucleophilic substitutions, ring-opening additions, alkoxylations and/or transalkoxylations, hydrosilylations, olefin metatheses, condensations, radical couplings and/or polymerizations, and the like, as well as combinations thereof.

Typically, the functionalized polyolefin (B) and the polysiloxane (A) are coupleable/reactable via hydrosilylation reaction or condensation reaction. As such, in certain embodiments, each functional group Y of the functionalized polyolefin (B) may selected from hydrosilylatable groups and condensable groups.

In some embodiments, each functional group Y is a hydrosilylatable group. Examples of such hydrosilylatable groups include the olefinically-unsaturated groups (e.g. ethylenically unsaturated groups) described above with respect to the hydrosilylatable groups suitable for functional group X. Other examples of hydrosilylatable groups suitable for functional group Y include hydridosilyl groups. Examples of such hydridosilyl groups may be generally represented by the subformula —[D]_{f}-Si(R⁵)₂H, where D is a divalent linking group, subscript f is 0 or 1, and each R⁵ is independently H or a hydrocarbyl group. Such moieties may be selected, or otherwise provided, based on a particular alpha-olefin-functional organosilicon compound polymerized in the preparation of the functionalized polyolefin (B). For example, in some embodiments, the functionalized polyolefin (B) comprises a copolymer of ethylene and 7-octenyldimethylsilane, such that, with regard to the preceding general unit formula of the functionalized polyolefin (B) and subformula of the functional group Y, each R³ is H, each subscript f is 1, each linking group D is —(CH₂)₆—, and each R⁵ is methyl. In specific embodiments, the functionalized polyolefin (B) comprises the polymerization reaction product of ethylene, an alkenyl-functional silane compound, and optionally one or more additional alpha-olefins (e.g. propene, butene, etc.). In such embodiments, examples of suitable alkenyl-functional silane compounds include 7-octentyldimethylsilane (ODMS), 5-hexenyldimethylsilane (HDMS), allyldimethylsilane (ADMS), and the like, as well as combinations thereof. It will be appreciated that such alkenyl-functional silane compounds may also be grafted onto a polyolefin polymer to prepare the functionalized polyolefin (B). The particular method used to prepare the functionalized polyolefin (B) is not particularly limited, and numerous examples of such methods are known in the art.

In addition to the preceding example, one of skill in the art will appreciate that other alpha-olefin-functional organosilicon compounds may likewise be used to prepare the functionalized polyolefin (B) to give hydridosilyl groups suitable for functional group Y. More specifically, such organosilicon compounds may be represented by the formula H₂C═C(H)-[D]_{f}—Si(R⁵)₂H, where each R⁵, D, and subscript f are as defined above. In some instances, divalent linking group D may be silyl or siloxy group.

In some embodiments, each functional group Y is a condensable group, i.e., capable of participating in a condensation reaction. In specific embodiments, each functional group Y comprises a condensable group selected from anhydrides and amines.

Examples of suitable anhydrides and amines for functional group Y generally include those described above with respect to condensable groups suitable for functional group X. However, in view of the preceding examples and descriptions of the functionalized polyolefin (B), one of skill in the art will appreciate that anhydrides available from anhydride-functional compounds with olefinic unsaturation will be particularly suitable for use in some embodiments, such as where the anhydride-functional compound can be readily copolymerized with an alpha-olefin monomer (e.g. ethene), or grafted onto an alpha-olefin homopolymer.

With further reference to the general unit formula of the functionalized polyolefin (B), as introduced above subscripts o and p are each mole fractions such that d+e=1. In general, 0<d<1 and 0<e<1, such that the functionalized polyolefin (B) may comprise at least one functional group Y, and theoretically many of such groups, but is not fully-substituted in terms of each olefin subunit present in the functionalized polyolefin (B) (e.g. as indicated by subscript e>0. In some embodiments, the moieties indicated by subscript d comprise from 0.01 to 5%, alternatively from 0.01 to 2.5% of the total number of olefin subunits in the functionalized polyolefin (B) (e.g. d+e). In these of other embodiments, the moieties indicated by subscript d may comprise from 0.05 to 10 wt. % of the functionalized polyolefin (B) (e.g. by total weight).

The particular properties and physical characteristics of the functionalized polyolefin (B) may be varied. In some embodiments, the functionalized polyolefin (B) comprises a number average molecular weight of from 5 to 100 kDa, such as from 5 to 80, alternatively from 5 to 60, alternatively from 5 to 50, alternatively from 5 to 40, alternatively from 5 to 30 kDa. In these or other embodiments, the functionalized polyolefin (B) comprises a molecular weight distribution, as represented by the polydispersity index (PDI) (e.g. as determined by gel permeation chromatography (GPC)), of from 1 to 12, such as from 1 to 10. In some embodiments, the functionalized polyolefin (B) exhibits a PDI of from 1 to 5, such as from 1 to 4, alternatively from 1.5 to 3.5, from 1.75 to 3.25, alternatively from 2 to 3. In some embodiments, the functionalized polyolefin (B) exhibits a PDI of from 3 to 6, such as from 3.5 to 5.5, alternatively from 4 to 5.

The amount of components (A) and (B) in the flowable composition may vary, as will be best understood in view of the additional description below. Typically, the polysiloxane (A) is present in the flowable composition in an amount of from 60 to 99 wt. %, and the functionalized polyolefin (B) is present in the flowable composition in an amount of from 1 to 40 wt. %, each percentage based on the combined weight of components (A) and (B). In some embodiments, the polysiloxane (A) is present in the flowable composition in an amount of from 75 to 99 wt. %, based on the combined weight of components (A) and (B). In these or other embodiments, the polyolefin (B) is present in the flowable composition in an amount of from 1 to 25 wt. %, based on the combined weight of components (A) and (B).

With regard to the preceding embodiments and component amounts, it is to be understood that the balance of the flowable composition, if any, may comprise one or more additional components of the flowable composition. For example, as will be better understood in view of the additional description and methods described herein, the flowable composition may comprise a catalyst, a solvent or carrier vehicle, or a reaction promotor. In some embodiments, however, the flowable composition is free from, alternatively substantially free from, a reaction catalyst or promotor. In these or other embodiments, the flowable composition comprises less than 1 wt. % solvent, based on the total weight of the flowable composition. In other embodiments, the flowable composition is substantially free from, alternatively is free from, solvents or carrier vehicles (i.e., aside from component (A) itself).

It will also be appreciated that amounts outside of the ranges and ratios above may also be utilized. However, as will also be better understood in view of the additional description and methods described herein, increased loadings of the functionalized polyolefin (B) may result in macrophase separation due to poor compatibilization.

In some embodiments, the flowable composition comprises a (C) catalyst adapted to facilitate a coupling reaction between the functional groups X of the polysiloxane (A) and functional groups Y of the functionalized polyolefin (B).

The use of the catalyst (C), as well as the particular type or specific compound(s) selected for use in or as the catalyst (C), will be readily selected by those of skill in the art based on the particular polysiloxane (A) and functionalized polyolefin (B) selected. More specifically, the catalyst (C) is not particularly limited, but is instead selected to catalyze the coupling of components (A) and (B), and may thus comprise or be any compound suitable for facilitating the reaction of the polysiloxane (A) and the functionalized polyolefin (B) (e.g. via reaction of/including functional groups X and functional groups Y), as will be understood by one of skill in the art in view of the description herein. For example, in certain embodiments, the catalyst (C) is selected from those facilitating reactions including hydrosilylation, condensation, displacement, ring-opening, nucleophilic substitution, and the like, as well as combinations of such reactions. It is to be appreciated that the catalyst (C) may itself comprise more than one type of catalyst and/or the reaction may utilize more than one type of catalyst (C), such as two, three, or more different catalysts (C).

In specific embodiments, the catalyst (C) comprises, alternatively is, a hydrosilylation catalyst. In such embodiments, functional groups X and functional groups Y are complementary coupleable hydrosilylatable groups.

Hydrosilylation catalysts suitable for use in the flowable composition are not particularly limited and may be any known catalyst for catalyzing hydrosilylation reactions. Combinations of different hydrosilylation catalysts may also be utilized.

In certain embodiments, the hydrosilylation catalyst comprises a Group VIII to Group XI transition metal. Group VIII to Group XI transition metals refer to the modern IUPAC nomenclature. Group VIII transition metals are iron (Fe), ruthenium (Ru), osmium (Os), and hassium (Hs); Group IX transition metals are cobalt (Co), rhodium (Rh), and iridium (Ir); Group X transition metals are nickel (Ni), palladium (Pd), and platinum (Pt); and Group XI transition metals are copper (Cu), silver (Ag), and gold (Au). Additional examples of catalysts suitable for the hydrosilylation catalyst include rhenium (Re), molybdenum (Mo), Group IV transition metals (i.e., titanium (Ti), zirconium (Zr), and/or hafnium (Hf)), lanthanides, actinides, and Group I and II metal complexes (e.g. those comprising calcium (Ca), potassium (K), strontium (Sr), etc.). Combinations, complexes (e.g. organometallic complexes), and other forms of such metals may also be utilized as the hydrosilylation catalyst.

The hydrosilylation catalyst may be in any suitable form. For example, the hydrosilylation catalyst may be a solid, or instead by may be disposed in or on a solid carrier. Examples of solid catalysts typically include platinum-based catalysts, palladium-based catalysts, and similar noble metal-based catalysts, and also nickel-based catalysts. Specific examples thereof include elemental nickel, palladium, platinum, rhodium, cobalt, and similar metals, and also elemental mixtures/combinations such as platinum-palladium, nickel-copper-chromium, nickel-copper-zinc, nickel-tungsten, nickel-molybdenum, and the like, as well as Cu—Cr, Cu—Zn, Cu—Si, Cu—Fe—Al, Cu—Zn—Ti, and similar copper-containing catalysts. Examples of carriers include activated carbons, silicas, silica aluminas, aluminas, zeolites and other inorganic powders/particles (e.g. sodium sulphate), and the like. The hydrosilylation catalyst may also be disposed in a vehicle, e.g. a solvent which solubilizes the hydrosilylation catalyst, alternatively a vehicle which merely carries, but does not solubilize, the hydrosilylation catalyst. Such vehicles are known in the art.

In specific embodiments, the hydrosilylation catalyst comprises platinum. In these embodiments, the hydrosilylation catalyst is exemplified by platinum black, chloroplatinic acids (e.g. chloroplatinic acid hexahydrate, reaction products of chloroplatinic acid and a monohydric alcohol, or aliphatically-unsaturated organosilicon compound such as divinyltetramethyldisiloxane, etc.), platinum bis(ethylacetoacetate), platinum bis(acetylacetonate), platinum chloride, complexes of any such compounds with olefins or organopolysiloxanes, and microencapsulated platinum compounds (e.g. matrix or core-shell type). For example, suitable complexes of platinum with organopolysiloxanes, such as 1,3-diethenyl-1,1,3,3-tetramethyldisiloxane complexes with platinum, may be used directly or, alternatively, in microencapsulated form (e.g. in a resin matrix).

The hydrosilylation catalyst may be a photoactivatable hydrosilylation catalyst, which may initiate curing via irradiation (e.g. upon exposure to radiation having a wavelength of from 150 to 800 nm) and/or heat.

Specific examples of photoactivatable hydrosilylation-reaction catalysts suitable for the catalyst (C) include platinum(II) 8-diketonate complexes such as platinum(II) bis(2,4-pentanedioate), platinum(II) bis(2,4-hexanedioate), platinum(II) bis(2,4-heptanedioate), platinum(II) bis(1-phenyl-1,3-butanedioate, platinum(II) bis(1,3-diphenyl-1,3-propanedioate), platinum(II) bis(1,1,1,5,5,5-hexafluoro-2,4-pentanedioate); (η-cyclopentadienyl)trialkylplatinum complexes, such as (Cp)trimethylplatinum, (Cp)ethyldimethylplatinum, (Cp)triethylplatinum, (chloro-Cp)trimethylplatinum, and (trimethylsilyl-Cp)trimethylplatinum, where Cp represents cyclopentadienyl; triazene oxide-transition metal complexes, such as Pt[C₆H₅NNNOCH₃]₄, Pt[p-CN—C₆H₄NNNOC₆H₁₁]₄, Pt[p-H₃COC₆H₄NNNOC₆H₁₁]₄, Pt[p-CH₃(CH₂)ₓ—C₆H₄NNNOCH₃]₄, 1,5-cyclooctadiene·Pt[p-CN—C₆H₄NNNOC₆H₁₁]₂, 1,5-cyclooctadiene·Pt[p-CH₃O—C₆H₄NNNOCH₃]₂, [(C₆H₅)₃P]₃Rh[p-CN—C₆H₄NNNOC₆H₁₁], and Pd[p-CH₃(CH₂)ₓ—C₆H₄NNNOCH₃]₂, where x is 1, 3, 5, 11, or 17; (η-diolefin)(σ-aryl)platinum complexes, such as (η⁴-1,5-cyclooctadienyl)diphenylplatinum, η⁴-1,3,5,7-cyclooctatetraenyl)diphenylplatinum, (η⁴-2,5-norboradienyl)diphenylplatinum, (η⁴-1,5-cyclooctadienyl)bis-(4-dimethylaminophenyl)platinum, (η⁴-1,5-cyclooctadienyl)bis-(4-acetylphenyl)platinum, and (η⁴-1,5-cyclooctadienyl)bis-(4-trifluormethylphenyl)platinum. In specific embodiments, the photoactivatable hydrosilylation-reaction catalyst of the catalyst (C) is a Pt(II) β-diketonate complex, such as platinum(II) bis(2,4-pentanedioate).

It will be appreciated that the compounds described above with regard to the catalyst (C) above, i.e., when comprising or being the hydrosilylation catalyst, may generally promote rapid crosslinking of components (A) and (B) of the flowable composition (i.e., when coupleable/cross-linkable via hydrosilylation, as described above), even at room temperature. As such, in certain embodiments, the flowable composition further comprises a reaction inhibitor, which may be further defined as a cross-linking reaction inhibitor, a hydrosilylation reaction inhibitor, or a stabilizer. Suitable inhibitors are known in the art, and generally include compounds that stop catalysis, yet are volatile or readily decomposed by heat or light (e.g. UV). Examples of such inhibitors typically include relatively low-boiling alkyne- and alkene-based compounds with electron-withdrawing groups, which complex with catalytic metals and thereby block activity thereof until heat is applied. General examples of inhibitors include acetylenic alcohols having boiling points of less than 250° C. (e.g. 2-methyl-3-butyn-2-ol, 1-ethynylcyclohexanol (ETCH)), as well as various fumarates, maleates (e.g. diallyl maleate), small vinyl-functional siloxanes (e.g. tetravinyl-tetramethyltetrasiloxane), ethynylalkenes (e.g. 3-methyl-3-penten-1-yne, 3-methyl-3-hexen-1-yne, 3,5-dimethyl-3-hexen-1-yne, 3-ethyl-3-buten-1-yne, 3-phenyl-3-buten-1-yne, etc.), dialkyl esters of acetylenedicarboxylic acids (e.g. dimethyl acetylenedicarboxylate (DMAD)), and the like, as well as various derivatives thereof. One of skill in the art will select such an inhibitor for use in or as the reaction inhibitor in view of the particular other components utilized for the flowable composition, as well as the intended use thereof, including the uses and processes disclosed herein. For example, it is well understood that particular hydrosilylation reaction inhibitors/stabilizers exhibit different compatibilities and operating windows (e.g. in terms of light and/or heat sensitivity, require loading amounts, etc.), such that a person of skill in the art will readily select an appropriate inhibitor for use as the reaction inhibitor, if needed, based on the description of the compositions and methods provided herein.

In specific embodiments, the catalyst (C) comprises, alternatively is, a condensation catalyst. In such embodiments, functional groups X and functional groups Y are complementary condensable groups (e.g. amine (X)+anhydride (Y)).

Condensation catalysts suitable for use in the flowable composition may be any known compound (or combination) compatible with components (A) and (B) and capable of catalyzing or otherwise facilitating a condensation reaction of functional groups X and Y. Combinations of different hydrosilylation catalysts may also be utilized.

Examples of condensation catalysts generally inorganic and organic bases and acids (i.e., an acid-type or base-type catalyst), which may comprise metal atoms or, alternatively, may be substantially free from, alternatively free from metal atoms. Examples of such catalysts generally include mineral acids and bases (e.g. H₂SO₄, LiOH, NaOH, KOH, CsOH, etc.), organic bases and amines (e.g. tetramethylammonium hydroxide ((CH₃)₄NOH), 1,8-diazabicyclo[5.4.0]undec-7-ene (DBU)), and organic and inorganic acids (e.g. carboxylic acids, sulfamic acids, etc.), and the like, as well as derivatives, modifications, and combinations thereof.

When utilized, particular condensation catalysts will be selected by those of skill in the art in view of the particular components and conditions utilized in the flowable composition, and processes involving the same. Particular limitations will be understood in view of the description below. For example, in some embodiments, residual amounts of catalyst may be carried forward from the flowable composition to other compositions and/or processes that may be incompatible with certain types of condensation catalysts. As such, in certain embodiments, the catalyst (C), optionally the flowable composition as a whole, is substantially free from, alternatively free from, one or more metal-based condensation catalysts, strong acids and bases, oxidizing compounds, and the like.

The catalyst (C) may be utilized in any amount, which will be selected by one of skill in the art, e.g. dependent upon the particular catalyst (C) selected (e.g. the concentration/amount of active components thereof, the type of catalyst being utilized, the type of coupling reaction being performed, etc.), the scale being utilized (e.g. total amounts of components (A) and (B), relative amounts of functional groups X and functional groups Y, etc.), etc. As will be best understood in view of the description below, the molar ratio of the catalyst (C) to components (A) and/or (B) utilized in the reaction may influence the rate and/or amount of reaction, when desired. Thus, the amount of the catalyst (C) as compared to components (A) and/or (B), as well as the molar ratios therebetween, may vary. Typically, these relative amounts and the molar ratio are selected to maximize the coupling of components (A) and (B) (i.e., the reaction of functional groups X and Y) while minimizing the loading of the catalyst (C) (e.g. for increased economic efficiency of the reaction, increased ease of purification of the reaction product formed, etc.).

For example, it will be appreciated that, beyond a minimum threshold value, decreasing catalyst loadings will result in poor reactivity, and thus may not be able to achieve the properties and effects demonstrated and described herein. With regard to the present embodiments, such a minimum threshold is generally applicable to the hydrosilylation-mediated coupling reaction of components (A) and (B) described herein. As such, in typical embodiments where the functional groups X and functional groups Y are complementary coupleable hydrosilylatable groups, the flowable composition comprises the hydrosilylation catalyst of catalyst (C) in an amount of from 1 to 100 ppm, alternatively from 5 to 100 ppm. However, it will also be appreciated that loadings outside these ranges may be utilized to realize the benefits described herein, and one of skill in the art will be able to determine proper catalyst loadings (e.g. based on reactivity rates, compatibilization of components (A) and (B), etc.) in view of the description and examples herein.

In yet other embodiments, the flowable composition is substantially free, alternatively is free from a reaction catalyst or promotor, including those described above with regard to the catalyst (C). As will be understood in view of the additional description herein, certain features of the flowable composition and related methods and compositions may be realized and/or achieved without the use of a catalyst or promotor. For example, in specific embodiments, the functional groups X and functional groups Y are complementary condensable groups (e.g. amine (X)+anhydride (Y)), and the flowable composition is substantially free, alternatively is free from a condensation catalyst or promotor.

In certain embodiments, the catalyst (C) is utilized in the flowable composition in an amount of from 0.000001 to 5 wt. %, based on the total amount of component (A) utilized (i.e., wt./wt.). For example, the catalyst (C) may be used in an amount of from 0.00001 to 5 wt. %, such as from 0.00001 to 4, alternatively from 0.00001 to 3, alternatively from 0.00001 to 2, alternatively from 0.0001 to 2, alternatively from 0.0001 to 1, alternatively from 0.0001 to 0.5, alternatively from 0.001 to 0.5, alternatively of from 0.005 to 0.5, wt. %, based on the total amount of component (A) utilized. Likewise, or alternatively, the catalyst (C) may be utilized in the flowable composition in an amount of from 0.000001 to 5 wt. %, based on the total amount of component (B) utilized (i.e., wt./wt.). For example, the catalyst (C) may be used in an amount of from 0.00001 to 5 wt. %, such as from 0.00001 to 4, alternatively from 0.00001 to 3, alternatively from 0.00001 to 2, alternatively from 0.0001 to 2, alternatively from 0.0001 to 1, alternatively from 0.0001 to 0.5, alternatively from 0.001 to 0.5, alternatively of from 0.005 to 0.5, wt. %, based on the total amount of component (B) utilized.

In some embodiments (e.g. when the type of crosslinking reaction dictates a stoichiometric loading), the amount of the catalyst (C) utilized may be selected and/or determined on a molar ratio based on one or more components of the flowable composition, as will be understood by those of skill in the art. In such embodiments, the catalyst (C) may be utilized in the flowable composition in an amount of from 0.0001 to 5 mol %, based on the total amount of component (A) and/or component (B) utilized. For example, the catalyst (C) may be used in an amount of from 0.0005 to 5, alternatively of from 0.0005 to 3, alternatively of from 0.0005 to 1, alternatively of from 0.001 to 1 mol %, based on the total amount of component (A) utilized.

As introduced above, the flowable composition comprises the functionalized polyolefin (B) dispersed in the polysiloxane (A). More specifically, as described in further detail herein, the flowable composition presents as a flowable dispersion comprising a continuous phase composed of the polysiloxane (A) and a discontinuous phase composed of the polyolefin (B). Said differently, the flowable composition comprises domains of the polyolefin (B) (i.e., “polyolefin domains”) dispersed in matrix silicone matrix formed by the polysiloxane (A). In certain embodiments, the polyolefin domains are uniformly dispersed through the continuous phase of the polysiloxane (A).

Typically, the flowable composition comprises a number average polyolefin domain size of less than 25 μm in diameter (i.e., from greater than 0 to less than 25 μm), e.g. as determined via optical at high magnification (e.g. 256×, 640×) or electron microscopy (e.g. via Scanning Electron Microscope (SEM)). In some embodiments, the flowable composition comprises a number average polyolefin domain size of less than 20 μm, alternatively less than 15 μm, alternatively less than 10 μm. The number average polyolefin domain size is greater than 0 μm.

Typically, the flowable composition exhibits a viscosity of from 100 to 1,000,000 mPa-s, such as from 400 to 900,000, alternatively from 8,000 to 60,000 mPa-s at 25° C. (e.g. as determined via viscometer, such as a Brookfield LV DV-E viscometer equipped with an appropriate spindle; alternatively via parallel plate geometry). In some embodiments, the flowable composition exhibits a viscosity of from 80 to 1,000 Pa-s at 10 s⁻¹ depending on formulation and/or intended use, which will be understood in view of the description and embodiments exemplified herein. For example, the flowable composition may exhibit a viscosity of from 85 to 450 Pa-s at 10 s⁻¹ as a pure dispersion, from 600 to 1,000 Pa-s at 10 s⁻¹ as a curable composition, and/or from 325 to 500 Pa-s at 10 s⁻¹ as a liquid silicone rubber (LSR) composition).

Typically, the flowable composition is substantially free from, alternatively is free from, a carrier vehicle (i.e., solvents, diluents, dispersants, etc.). In specific embodiments, the flowable composition is substantially free from, alternatively is free from, a carrier vehicle, comprises a number average polyolefin domain size of less than 20 μm, and exhibits a viscosity of from 10,000 to 75,000 mPa-s.

As introduced above, a method of preparing the flowable composition (the “preparation method”) is also provided. In general, the preparation method allows for the preparation of the flowable composition from the polysiloxane (A) and the functionalized polyolefin (B), which are based on otherwise non-compatible chemistries (i.e., polysiloxanes and polyolefins). Moreover, the preparation method provides the flowable composition as a uniform dispersion having small discontinuous phase domains (e.g. polyolefin domains) and a useful viscosity, which, as described in further detail below, may be formulated as a curable composition.

The preparation method comprises dispersing the functionalized polyolefin (B) in the polysiloxane (A).

As will be appreciated from the description herein, the polysiloxane (A) is capable of compatibilizing the functionalized polyolefin (B), e.g. via additive cross-linking reaction between the functional groups (X) and functional groups (Y), respectively, as described above. As such, dispersing the functionalized polyolefin (B) in the polysiloxane (A) generally comprises combining together components (A) and (B), optionally with other components, to form a mixture (i.e., the “compatibilization mixture”), and then reacting components (A) and (B) to compatibilize the functionalized polyolefin (B).

With regard to the method components, the polysiloxane (A) may be prepared (i.e., as part of the preparation method) or otherwise obtained, i.e., as a prepared reagent/feedstock. Methods of preparing cross-linkable/reaction coupleable polydiorganosiloxanes such as the polysiloxane (A) are known in the art, with suitable precursors and starting materials commercially available from various suppliers. Preparing the polysiloxane (A), when part of the preparation method, is typically performed prior to combining the same with any other components of the flowable composition. The functionalized polyolefin (B) may also be prepared as part of the preparation method, or otherwise obtained for use therein. Methods of preparing such functionalized polyolefins are readily available and known in the art, as will be understood in view of the description of component (B) herein.

Components (A) and (B) may be utilized in any amount, bearing in mind the upper limit/ratio of the functionalized polyolefin (B) in the polysiloxane (A) described above. As such, suitable amounts which will be selected by one of skill in the art, e.g. dependent upon the particular components selected, the cross-linking reaction parameters employed for the compatibilization, the scale of the compatibilization (e.g. total amounts of components (A) and (B) in the flowable composition being prepared), etc.

In general, components (A) and (B) may independently be utilized in any form, such as neat (i.e., absent solvents, carrier vehicles, diluents, etc.), or disposed in a carrier vehicle, such as a solvent or dispersant, as described in further detail below. However, in certain embodiments, components (A) and (B) are utilized neat, or otherwise in a form substantially free from, alternatively free from a carrier vehicle. When substantially free from carrier vehicles, components (A) and (B) will typically be free from (or at substantially free from), water and carrier vehicles/volatiles reactive with any components to participate in the compatibilization (e.g. components (A) and (B), optionally catalyst (C) and/or the reaction inhibitor, if utilized; collectively, the “compatibilization components”). As such, in some embodiments, the compatibilization, or the preparation method as a whole, is carried out in the absence of carrier vehicles/volatiles that are reactive with the polysiloxane (A) (i.e., at the polysiloxane backbone or the functional groups (X)), the functionalized polyolefin (B) (e.g. at the functional groups (Y), or any one or more other components being utilized to prepare the flowable composition. For example, in certain embodiments, the preparation method may comprise stripping a mixture comprising one or more of the compatibilization components (e.g. of volatiles, solvents, etc.) prior to combining the same with any one or other components being utilized in the preparation method. Techniques for stripping polysiloxanes, polyolefins, and reaction catalysts are generally known in the art, and may include heating, drying, applying reduced pressure/vacuum, azeotroping with solvents, utilizing drying agents such as molecular sieves, etc., and combinations thereof.

In some embodiments, one or more of the compatibilization components may be combined with a carrier vehicle, e.g. prior to and/or during the compatibilization of component (B). When combined prior to the compatibilization, e.g. as part of the preparation of such component, or to otherwise facilitate providing and/or metering out a component to the compatibilization mixture, the stripping process above may be carried out. When the carrier vehicle is to be present during the compatibilization, it will be appreciated that suitable choices will be limited based on compatible with the components and conditions of the compatibilization process.

With regard to carrier vehicles generally, examples typically include oils (e.g. organic oils and/or a silicone oils), fluids, solvents, etc., and a combinations thereof. For example, in some embodiments, one or more of the components of the compatibilization disposed in a carrier fluid prior to being combined with the other components of the compatibilization. In some such embodiments, the carrier fluid comprises, alternatively consists essentially of, a silicone fluid. The silicone fluid is typically a low viscosity and/or volatile siloxane. In some embodiments, the silicone fluid is a low viscosity organopolysiloxane, a volatile methyl siloxane, a volatile ethyl siloxane, a volatile methyl ethyl siloxane, or the like, or combinations thereof. Typically, the silicone fluid has a viscosity at 25° C. in the range of 1 to 1,000 mPa-s. Specific examples of suitable silicone fluids include hexamethylcyclotrisiloxane, octamethylcyclotetrasiloxane, decamethylcyclopentasiloxane, dodecamethylcyclohexasiloxane, octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, hexamethyl-3,3, bis{(trimethylsilypoxy}trisiloxane pentamethyl{(trimethylsilyl)oxy}cyclotrisiloxane as well as polydimethylsiloxanes, polyethylsiloxanes, polymethylethylsiloxanes, polymethylphenylsiloxanes, polydiphenylsiloxanes, caprylyl methicone, hexamethyldisiloxane, heptamethyloctyltrisiloxane, hexyltrimethicone, and the like, as well as derivatives, modifications, and combinations thereof. Additional examples of suitable silicone fluids include polyorganosiloxanes with suitable vapor pressures, such as from 5×10⁻⁷ to 1.5×10⁻⁶ m²/s, such as DOWSIL® 200 Fluids and DOWSIL® OS FLUIDS, which are commercially available from Dow Silicones Corporation of Midland, Mich., U.S.A.

In other such embodiments, the carrier fluid comprises, alternatively consists essentially of, an organic fluid, which typically comprises an organic oil including a volatile and/or semi-volatile hydrocarbon, ester, and/or ether. General examples of such organic fluids include volatile hydrocarbon oils, such as C₆-C₁₆ alkanes, C₈-C₁₆ isoalkanes (e.g. isodecane, isododecane, isohexadecane, etc.) C₈-016 branched esters (e.g. isohexyl neopentanoate, isodecyl neopentanoate, etc.), and the like, as well as derivatives, modifications, and combinations thereof. Additional examples of suitable organic fluids include aromatic hydrocarbons and aliphatic hydrocarbons. Hydrocarbons include isododecane, isohexadecane, Isopar L (C₁₁-C₁₃), Isopar H (C₁₁-C₁₂), hydrogentated polydecene. Ethers and esters include isodecyl neopentanoate, neopentylglycol heptanoate, glycol distearate, dicaprylyl carbonate, diethylhexyl carbonate, propylene glycol n-butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, octyl ether, octyl palmitate, and combinations thereof.

In yet other such embodiments, the carrier fluid comprises, alternatively consists essentially of, an organic solvent. Examples of the organic solvents include those comprising a ketone, such as acetone, methylethyl ketone, and methyl isobutyl ketone; an aromatic hydrocarbon, such as benzene, toluene, and xylene; an aliphatic hydrocarbon, such as heptane, hexane, and octane; a glycol ether, such as propylene glycol methyl ether, dipropylene glycol methyl ether, propylene glycol n-butyl ether, propylene glycol n-propyl ether, and ethylene glycol n-butyl ether; a halogenated hydrocarbon, such as dichloromethane, 1,1,1-trichloroethane and methylene chloride; chloroform; dimethyl sulfoxide; dimethyl formamide, acetonitrile; tetrahydrofuran; white spirits; mineral spirits; naphtha; n-methylpyrrolidone; and the like, as well as derivatives, modifications, and combination thereof.

As introduced above, and notwithstanding the preceding section, the compatibilization reaction (i.e., the cross-linking reaction of components (A) and (B)) may be carried out under conditions substantially free from carrier vehicle. Indeed, as will be appreciated from the examples and additional description herein, the polysiloxane (A) may be utilized as a carrier vehicle in the compatibilization.

As also introduced above, the compatibilization mixture may comprise components other that (A) and (B). For example, in certain embodiments, the additive cross-linking reaction (i.e., the compatibilization) is further defined as the hydrosilylation reaction, where the functional groups (X) and functional groups (Y) are selected from the complementary hydrosilylatable groups (e.g. where each X is the silicon-bonded olefinically-ethylenically unsaturated group, and each Y comprises the hydridosilyl group). In such embodiments, the compatibilization mixture will typically include the hydrosilylation catalyst (C). In other embodiments, the compatibilization is further defined as the condensation reaction, where the functional groups (X) and functional groups (Y) are selected from the complementary condensable groups (e.g. where each X is the aminoalkyl group and each Y comprises the anhydride group). In some such embodiments, the compatibilization is free from catalyst (e.g. condensation catalyst (C)).

The compatibilization components are typically combined in a vessel or reactor to carry out the compatibilization and disperse component (B) in component (A), and thereby prepare the flowable composition. The compatibilization components may be fed together or separately to the vessel, or may be disposed in the vessel in any order of addition, and in any combination, to prepare the compatibilization mixture.

The compatibilization mixture may be prepared in batch, semi-batch, semi-continuous, or continuous processes, unless otherwise noted herein. In some embodiments, the flowable composition is prepared via dynamic coupling (sometimes referred to as dynamic cross-linking, although the coupling here is not necessarily a cross-linking), i.e., via mixture together the compatibilization components as the crosslinking is carried out. In this sense, the term “dynamic” indicates the compatibilization mixture is subjected to shear forces during the coupling/compatibilization step, in contrast to “static crosslinking” whereby a polymer is relatively immobilized during the crosslinking.

The compatibilization is typically conducted at an elevated temperature with mixing (e.g. under shear). As such, the vessel or reactor is typically heated, e.g. via a jacket, mantle, exchanger, bath, coils, etc., and equipped with mixing means for blending and/or shearing the compatibilization mixture. In general, the elevated temperature for compatibilization is from 100 to 200° C. In specific embodiments, the elevated temperature is from 100 to 180, alternatively from 110 to 180, alternatively from 120 to 180° C.

With regard to the mixing/shear, the silicone-polyolefin composition is typically homogenized via melt blending or extruding the silicone-polyolefin composition at the elevated temperature to prepare the silicone-polyolefin blend. As such, while other reactors and mixing/blending techniques (e.g. using twin-rotor mixers, ribbon blenders, solution blenders, co-kneaders, screw extruders, static mixers, Banbury-type mixers, etc.) may be utilized, in certain embodiments the reactor/vessel is an extruder or melt blender. However, one of skill in the art will understand that other mixers may also be utilized.

As the compatibilization progresses and the compatibilization components are mixed and reacted, the functionalized polyolefin (B) is taken into and dispersed uniformly throughout the polysiloxane (A), thereby preparing the flowable silicone-polyolefin composition.

A curable composition comprising the flowable silicone-polyolefin composition is also provided herein. In general, the curable composition comprises the flowable silicone-polyolefin composition, and one or more cure components such as a filler, a cure catalyst, a cross-linker, or combinations thereof. In the same nature as the flowable composition described above, the curable composition does not require a carrier vehicle or solvent under typical circumstances. As such, the curable composition may be solvent-free (i.e., free from, alternatively substantially free from, a carrier vehicle or solvent).

In certain embodiments, the curable composition comprises the filler, such as an electrically and/or thermally conductive or non-conductive fillers, mineral filler, etc. Examples of electrically conductive fillers include those comprising a metal or a conductive non-metal, or metal or non-metal particles having an outer surface of a metal (e.g. a noble metal such as silver, gold, platinum, palladium, and alloys thereof, or a base metal such as nickel, aluminum, copper, or steel), including those also comprising a core of particles consisting of copper, solid glass, hollow glass, mica, nickel, ceramic fiber, or polymerics such as polystyrene, polymethylmethacrylate, etc. Example of thermally conductive fillers include those comprising aluminum, copper, gold, nickel, silver, alumina, magnesium oxide, beryllium oxide, chromium oxide, titanium oxide, zinc oxide, barium titanate, diamond, graphite, carbon or silicon nano-sized particles, boron nitride, aluminum nitride, boron carbide, titanium carbide, silicon carbide, and tungsten carbide. Examples of mineral fillers include titanium dioxide, aluminium trihydroxide (also called ATH), magnesium dihydroxide, mica, kaolin, calcium carbonate, non-hydrated, partially hydrated, or hydrated fluorides, chlorides, bromides, iodides, chromates, carbonates, hydroxides, phosphates, hydrogen phosphates, nitrates, oxides, and sulphates of sodium, potassium, magnesium, calcium, and barium; zinc oxide, aluminium oxide, antimony pentoxide, antimony trioxide, beryllium oxide, chromium oxide, iron oxide, lithopone, boric acid or a borate salt such as zinc borate, barium metaborate or aluminium borate, mixed metal oxides such as aluminosilicate, vermiculite, silica including fumed silica, fused silica, precipitated silica, quartz, sand, and silica gel; rice hull ash, ceramic and glass beads, zeolites, metals such as aluminium flakes or powder, bronze powder, copper, gold, molybdenum, nickel, silver powder or flakes, stainless steel powder, tungsten, hydrous calcium silicate, barium titanate, silica-carbon black composite, functionalized carbon nanotubes, cement, fly ash, slate flour, ceramic or glass beads, bentonite, clay, talc, anthracite, apatite, attapulgite, boron nitride, cristobalite, diatomaceous earth, dolomite, ferrite, feldspar, graphite, calcined kaolin, molybdenum disulfide, perlite, pumice, pyrophyllite, sepiolite, zinc stannate, zinc sulphide, wollastonite, and the like, as well as derivatives, modifications, and combinations thereof.

In certain embodiments, the curable composition comprises one or more reinforcing fillers, non-reinforcing fillers, or a mixture thereof. Examples of reinforcing fillers include of finely divided fillers such as high surface area fumed and precipitated silicas, including rice hull ash, fumed silica, silica aerogel, silica xerogel, and precipitated silica. Specific suitable precipitated calcium carbonates include Winnofil® SPM from Solvay and Ultrapflex® and Ultrapflex® 100 from Specialty Minerals, Inc. Examples of fumed silicas are known in the art and are commercially available, such as those sold under the name CAB-O-SIL by Cabot Corporation of Massachusetts, U.S.A. Examples of non-reinforcing fillers include finely divided fillers such as crushed quartz, diatomaceous earths, barium sulphate, iron oxide, titanium dioxide, carbon black, talc, and wollastonite. Other fillers which might be used alone or in addition to those above include carbon nanotubes, e.g. multiwall carbon nanotubes aluminite, hollow glass spheres, calcium sulphate (anhydrite), gypsum, calcium sulphate, magnesium carbonate, clays such as kaolin, aluminum trihydroxide, magnesium hydroxide (brucite), graphite, copper carbonate, e.g. malachite, nickel carbonate, e.g. zarachite, barium carbonate, e.g. witherite and/or strontium carbonate e.g. strontianite. Additional fillers suitable for use in the composition include aluminum oxide, silicates from the group consisting of olivine group, garnet group, aluminosilicates, ring silicates, chain silicates, and sheet silicates.

The amount of the filler present in the curable composition depends on various factors (e.g. the amount and/or type of the components of the flowable composition, the types and/or amounts of any additional materials present in the curable composition, etc.), and may be readily determined by one of skill in the art. The exact amount of the filler employed in a specific implementation of the curable composition will also depend on whether more than one type of filler is utilized. Typically, where present, the curable composition comprises the filler in an amount of from 0 to 70 wt. %, such as from 3 to 70, alternatively from 5 to 65, alternatively from 10 to 55 wt. %, based on the total weight of the curable composition (e.g. the total weight of the flowable silicone-polyolefin composition and the one or more cure components). In specific embodiments, the curable composition comprises the filler in an amount of from 20 to 50 wt. %, such as from 25 to 45, alternatively from 35 to 40, alternatively from 25 to 35 wt. %, based on the total weight of the curable composition.

In some embodiments, the curable composition comprises a cure catalyst. Typically, the cure catalyst is selected from hydrosilylation catalysts and condensation catalysts, such as those described above. In particular, in some embodiments, the catalyst utilized to prepare the flowable composition is conserved into the curable composition. In other words, in such embodiments, the cure catalyst of the curable composition is the same as the catalyst (C) of the flowable composition. In some such embodiments, the preparation method is carried out in a manner that preserves some of the catalyst (C) from the flowable composition to be utilized in a subsequent curing reaction. In other embodiments, the cure catalyst comprises a separate aliquot of the same catalyst utilized as the catalyst (C). In yet other embodiments, the cure catalyst is different than the catalyst (C), e.g. where the cure catalyst is a condensation catalyst and the catalyst (C) is the hydrosilylation catalyst, or vice versa. Typically, the cure catalyst is a hydrosilylation catalyst.

In some embodiments, the curable composition comprises a cure inhibitor, i.e., a reaction inhibitor suitable for preventing and/or minimizing unwanted premature cure of the curable composition. Examples of such cure inhibitors are described above with respect to the reaction inhibitors suitable for use in the flowable composition, which are also generally suitable for his in the curable composition.

In some embodiments, the curable composition comprises the cross-linker. In general, the cross-linker comprises, alternatively is, a compound comprising an average of at least two functional groups per molecule, where the functional groups are reactive with at least one other component of the curable composition. In some embodiments, the cross-linker comprises a functional group reactive with the polysiloxane (A), e.g. at the functional group(s) X, to form a bond therebetween (i.e., via additive cross-linking reaction). Similarly, in these or other embodiments, the cross-linker comprises a functional group reactive with the functionalized polyolefin (B), e.g. at the functional groups Y, to form a bond therebetween. In these or yet other embodiments, the cross-linker comprises a functional group reactive with the filler, e.g. directly or at a surface treatment/modification. In this fashion, the cross-linker may be used in the curing of the curable composition, i.e., to form a cured product therefrom, upon exposure to an appropriate curing condition.

In some embodiments, the functional groups of the cross-linker independently comprise a hydrosilylatable group or a condensable group. Typically, the particular functionality of the cross-linker is selected based on the other components of the curable composition. For example, in certain embodiments, the cross-linker comprises complementary functionality coupleable with the functional groups X, as described above.

In some embodiments, the cross-linker is an organosiloxane, and the functional groups are Si—H groups, i.e., such that the cross-linker may be further defined as an organohydrogensiloxane. In such embodiments, the cross-linker may comprise any combination of M, D, T and/or Q siloxy units, so long as the cross-linker includes at least two silicon-bonded hydrogen atoms per molecule. These siloxy units can be combined in various manners to form cyclic, linear, branched and/or resinous (three-dimensional networked) structures, as described above and in further detail below.

Because the cross-linker includes an average of at least two silicon-bonded hydrogen atoms per molecule, with reference to the siloxy units set forth above, the cross-linker may comprise any of the following siloxy units including silicon-bonded hydrogen atoms, optionally in combination with siloxy units which do not include any silicon-bonded hydrogen atoms: (R″₂H SiO_{1/2}), (R″H₂SiO_{1/2}), (H₃SiO_{1/2}), (R″HSiO_{2/2}), (H₂SiO_{2/2}), and/or (HSiO_{3/2}), where R″ is independently selected and defined above. In specific embodiments, the cross-linker is a substantially linear, alternatively linear, polyorganohydrogensiloxane. The substantially linear or linear polyorganohydrogensiloxane has unit formula: (HR¹⁰₂SiO_{1/2})_{v′}(HR¹⁰SiO_{2/2})_{w′}(R¹⁰₂SiO_{2/2})_{x′}(R¹⁰₃SiO_{1/2})_{y′}, where each R¹⁰ is an independently selected monovalent hydrocarbon group, subscript v′ is 0, 1, or 2, subscript w′ is 1 or more, subscript x′ is 0 or more, subscript y′ is 0, 1, or 2, with the provisos that a quantity (v′+y′)=2, and a quantity (v′+w′)≥3. The monovalent hydrocarbon group for R¹⁰ may be as described above for the monovalent hydrocarbon group for R¹ above. A quantity (v′+w′+x′+y′) may be 2 to 1,000. The polyorganohydrogensiloxane is exemplified by:
i) dimethylhydrogensiloxy-terminated poly(dimethyl/methylhydrogen)siloxane copolymer,
ii) dimethylhydrogensiloxy-terminated polymethylhydrogensiloxane,
iii) trimethylsiloxy-terminated poly(dimethyl/methylhydrogen)siloxane copolymer,
iv) trimethylsiloxy-terminated polymethylhydrogensiloxane, and/or
v) a combination of two or more of i), ii), iii), iv), and v). Suitable polyorganohydrogensiloxanes are commercially available from Dow Silicones Corporation of Midland, Michigan, USA.

In one specific embodiment, the cross-linker is linear and includes pendent silicon-bonded hydrogen atoms. In these embodiments, the cross-linker may be a dimethyl, methyl-hydrogen polysiloxane having the average formula;

(CH₃)₃SiO[(CH₃)₂SiO]_{x′}[(CH₃)HSiO]_{w′}Si(CH₃)₃

where x′ and w′ are defined above. One of skill in the art understands that in the exemplary formula above the dimethylsiloxy units and methylhydrogensiloxy units may be present in randomized or block form, and that any methyl group may be replaced with any other hydrocarbon group free of aliphatic unsaturation.

In another specific embodiment, the cross-linker is linear and includes terminal silicon-bonded hydrogen atoms. In these embodiments, the cross-linker may be an SiH terminal dimethyl polysiloxane having the average formula:

H(CH₃)₂SiO[(CH₃)₂SiO]_{x′}Si(CH₃)₂H

where x′ is as defined above. The SiH terminal dimethyl polysiloxane may be utilized alone or in combination with the dimethyl, methyl-hydrogen polysiloxane disclosed immediately above. When a mixture is utilized, the relative amount of each organohydrogensiloxane in the mixture may vary. One of skill in the art understands that any methyl group in the exemplary formula above may be replaced with any other hydrocarbon group free of aliphatic unsaturation.

Alternatively still, the cross-linker may include both pendent and terminal silicon-bonded hydrogen atoms.

In certain embodiments, the cross-linker may comprise an alkylhydrogen cyclosiloxane or an alkylhydrogen dialkyl cyclosiloxane copolymer. Specific examples of suitable organohydrogensiloxanes of this type include (OSiMeH)₄, (OSiMeH)₃(OSiMeC₆H₁₃), (OSiMeH)₂(OSiMeC₆H₁₃)₂, and (OSiMeH)(OSiMeC₆H₁₃)₃, where Me represents methyl (—CH₃). In these or other embodiments, the cross-linker may comprise an organopolysiloxane having both cyclic and linear moieties. In such embodiments, the silicon-bonded hydrogen atoms of the cross-linker may be present in the cyclic moiety, the linear moiety, or both.

The cross-linker may comprise a combination or two or more different organohydrogensiloxanes that differ in at least one property such as structure, molecular weight, monovalent groups bonded to silicon atoms and content of silicon-bonded hydrogen atoms.

In certain embodiments, the cross-linker is an organosiloxane, and the functional groups are vinyl groups, i.e., such that the cross-linker may be further defined as an organovinylsiloxane. Examples of such organovinylsiloxanes suitable for use as, or in, the cross-linker include the organohydrogensiloxane cross-linkers above, where the at least two silicon-bonded hydrogen atoms in the formulas of the organohydrogensiloxane are substituted with silicon-bonded vinyl groups. As one of skill in the art will readily appreciate the scope of such cross-linkers, and for sake of brevity, such organovinylsiloxanes are not specifically listed here, but are expressly and explicitly contemplated within the scope of the cross-linker.

In some embodiments, the curable composition may comprise the cross-linker in an amount to give a molar ratio of functional groups (X) in component (A) to silicon-bonded hydrogen atoms or vinyl groups in the cross-linker of from 1:1 to 30:1, alternatively from 2:1 to 20:1, alternatively from 3:1 to 10:1, alternatively from 3:1 to 7:1, alternatively from 3:1 to 5:1, alternatively from 2:1 to 10:1, alternatively from 2:1 to 7:1, alternatively from 2:1 to 5:1, alternatively from 2:1 to 4:1.

In certain embodiments, the cross-linker comprises, alternatively is, a silicone fluid. In some such embodiments, the cross-linker comprises comprising an average of at least two hydrosilylatable or condensable groups per molecule. Examples of suitable silicone fluids for use in or as the cross-linker include tetramethyltetravinyltetracyclosiloxane, pentamethylpentavinylcyclopentasiloxane, trimethyltrivinylcyclotrisiloxane, dimethylvinylsiloxy-terminated PDMS, α,ω-dimethylsilanol-terminated oligomeric PDMS, and α,ω-dimethylvinylsiloxy-terminated random copolymers of PDMS and polymethylvinylsiloxane (e.g. obtainable by base-catalyzed ring opening equilibrium polymerization of octamethyltetracyclosiloxane (D4) and tetramethyltetravinyltetracylcosiloxane with divinyl tetramethyldisiloxane, the product of which is subsequently neutralized, filtered, and stripped of volatile dimethylsiloxanes), and the like, and combinations thereof.

In some embodiments, the cross-linker comprises, alternatively is, a fluorosilicone. Examples of suitable fluorosilicones include fluorine-substituted analogs of the cross-linking compounds described herein, such as those where one or more of the silicon-bonded alkyl groups (e.g. R″, R¹⁰, and the silicon-bonded methyl groups) are instead fluorine-containing alkyl groups such as 3,3,3-trifluroropropyl groups, 9,9,9-8,8,-7,7,-6,6-nonafluorohexyl groups, etc. Specific examples include 3,3,3-trifluroropropyl-methylsiloxanes and 9,9,9-8,8,-7,7,-6,6-nonafluorohexyl-methylsiloxanes (aka perfluorobutylethyl-methylsiloxanes). In such embodiments, it will be appreciated that the polysiloxane (A) will typically be selected to be compatible with such a cross-liner, e.g. by selecting fluorinated substituents for at least a portion of the R¹ moieties set forth above. In a similar fashion, even when not fluorinated, the cross-linker and the polysiloxane (A) will typically be selected in view of one another, e.g. where at least a portion of moieties R¹ in the polysiloxane (A) are phenyl, and the cross-linker is selected from phenylmethyl silicones. Such selections and compatibility will be understood by those of skill in the art.

In certain embodiments, the curable composition further comprises one or more additional components, such as one or more additives. It is to be appreciated that such additives may be classified under different terms of art and, just because an additive is classified under a specific term and/or characterized according to a particular function does not mean that it is thusly limited to that function. Moreover, some additives may be present in a particular component of the curable composition, or instead may be incorporated when forming the curable. Theoretically, the curable composition may comprise any number of additional components and additives, e.g. depending on the particular type and/or function of the same in the curable composition. For example, in certain embodiments, the curable composition may comprise one or more additives comprising, alternatively consisting essentially of, alternatively consisting of: a filler treating agent; a binder; a thickener; a tackifying agent; an adhesion promotor; a compatibilizer; an extender; a plasticizer; an end-blocker; a drying agent; a colorant (e.g. a pigment, dye, etc.); an anti-aging additive; a biocide; a flame retardant; a corrosion inhibitor; a UV absorber; an anti-oxidant; a light-stabilizer; a catalyst (e.g. other than the catalyst (C)), procatalyst, or catalyst generator; an initiator (e.g. a heat activated initiator, an electromagnetically activated initiator, etc.); a photoacid generator; a heat stabilizer; and the like, as well as derivatives, modifications, and combinations thereof.

In some embodiments, the curable composition comprises a number average polyolefin domain size of less than 2 μm in diameter (e.g. as determined via SEM). In particular embodiments, the curable composition comprises a number average polyolefin domain size of less than 1.75 μm, alternatively less than 1.5 μm.

In some embodiments, the curable composition exhibits a viscosity of from 1,000 to 1,000,000 mPas, such as from 10,000 to 900,000, alternatively from 80,000 to 600,000 mPas at 25° C. (e.g. as determined via viscometer, such as a parallel plate viscometer). As described above with respect to the flowable composition, the viscosity of the curable composition may vary depending on formulation and/or intended use. For example, the curable composition may exhibit a viscosity of from 85 to 1000 Pas at 10 s⁻¹, such as from 625 to 1000 Pas at 10 s⁻¹.

In some embodiments, the curable composition is further defined as an uncured hybrid liquid silicone rubber (LSR).

A cured product is also provided. The cured product is formed from the curable composition. More specifically, the cured product is formed by curing the curable composition, e.g. via the crosslinking reaction described above. As such, a method of preparing the cured product is also provided, and generally comprises curing the curable composition. For example, in certain embodiments, curing the curable composition comprises heating the composition to an elevated temperature, such as a temperature of from 120 to 300, alternatively from 150 to 300, alternatively from 150 to 250, alternatively from 150 to 250, alternatively from 170 to 250, alternatively from 170 to 230° C., for a time sufficient to cure the composition. In some embodiments, the curable composition is cured at a temperature of from 180 to 220° C. for a time of from 1 to 10 minutes. In specific embodiments, curable composition is cured at a temperature of about 200 for about 2 minutes. In other embodiments, lower temperatures and/or longer cure times may also be utilized. For example, in some embodiments, the cured product is formed by curing the curable composition at a temperature of from 100 to 140, alternatively from 110 to 130, alternatively of about 120° C., for a time of from 3 to 10, alternatively from 4 to 8, alternatively of about 6 minutes.

In some embodiments, the cured product is prepared via injection molding or a similar technique enabled by the flowability of the flowable composition and curable compositions prepared therewith. In some embodiments, the curable composition is further defined as a curable hybrid liquid silicone rubber (LSR), and the cured product is further defined as a cured hybrid LSR. In some embodiments, the cured hybrid LSR exhibits a viscosity of from 325 to 1000 Pa·s at 10 s⁻¹, such as from 325 to 500 Pa·s at 10 s⁻¹.

A composite article comprising the cured product is also provided. More specifically, the composite article comprises a substrate and the cured product disposed on the substrate. The composite article may be is formed by disposing and, subsequently, curing the curable composition on the substrate. In some embodiments, the composite article is further defined as a hybrid LSR composite.

In view of the description above and examples below, it will be appreciated that the methods and compositions provided herein provide a cost-effective route to obtaining unique silicone-polyolefin hybrid materials due to inexpensive precursors and solvent-less preparations. These and other features of the cured product will be understood in view of the example below.

The following examples, illustrating embodiments of this disclosure, are intended to illustrate and not to limit the invention. Unless otherwise noted, all reactions are carried out under air, and all solvents, substrates, and reagents are purchased or otherwise obtained from various commercial suppliers (e.g. Gelest, Acros, Sigma-Aldrich) and utilized as received.

### Equipment and Characterization Parameters

The following equipment and characterization procedures/parameters are used to evaluate various physical properties of the compounds prepared in the examples below.

High-Temperature Gel Permeation Chromatography (GPC): The polymer samples were analyzed on a PolymerChar GPC-IR maintained at 160° C. The sample was eluted through 1× PLgel 20 um 50×7.5 mm guard column and 4× PLgel 20 um Mixed A LS 300×7.5 mm columns with 1,2,4-trichlorobenzene (TCB) stabilized by 300 ppm of butylated hydroxyl toluene (BHT) at a flowrate of 1 mL/min. Approximately 16 mg of polymer sample was weighed out and diluted with 8 mL of TCB by the instrument. For molecular weight, a conventional calibration of polystyrene (PS) standards (Agilent PS-1 and PS-2) was used with apparent units adjusted to homo-polyethylene (PE) using known Mark-Houwink coefficients for PS and PE in TCB at this temperature. Decane was used as an internal flow marker and retention time was adjusted to this peak. For the comonomer incorporation, co-polymers of known composition were used to develop a calibration curve for incorporation.

Hardness: Durometer hardness of cured products was measured according to ASTM D2240.

Elastomer Properties: Tensile strength, elongation, and modulus were measured using methods described in ASTM D412; and the toughness values calculated from the same stress-strain curves thus prepared. Tear strengths were measured according to ASTM D624, Die B.

### Materials

A brief summary is provided in Table 1 below, setting forth information as to certain abbreviations, shorthand notations, and components utilized in the Examples. Viscosity is typically reported as zero-shear viscosities measured at 25° C. Degree of polymerization (DP) is typically reported as number average DP, e.g. from NMR, IR, and/or GPC (e.g. relative to standards, such as polystyrene).

TABLE 1
Materials Utilized

| Component | Description |
|---|---|
| Vinyl PDMS-1 | α,ω-vinyl-terminated polydimethylsiloxane having a zero shear |
| | viscosity of about 45000 cP at 25° C. and a polydispersity index of |
| | about 2. |
| Amino PDMS-2 | α,ω-aminopropyl-terminated polydimethylsiloxane having a zero |
| | shear viscosity of about 10000 cP at 25° C. and a polydispersity |
| | index of about 2. |
| HDPE-1 | A copolymer of ethylene and dimethyl-7-octen-1-ylsilane having a |
| | molecular weight (Mn) of 9 kDa, polydispersity index of 2.84 and |
| | containing about 4 wt. % silane monomer. |
| HDPE-2 | A copolymer of ethylene and dimethyl-7-octen-1-ylsilane having a |
| | molecular weight (Mn) of 9 kDa, polydispersity index of 2.55 and |
| | containing about 4 wt. % silane monomer. |
| HDPE-3 | A copolymer of ethylene and dimethyl-7-octen-1-ylsilane having a |
| | molecular weight (Mn) of 12 kDa, polydispersity index of 2.42 and |
| | containing about 2.5 wt. % silane monomer. |
| HDPE-4 | A homopolymer of ethylene having a molecular weight (Mn) of 7 kDa |
| | and polydispersity index of 5.43, grafted with maleic anhydride, such |
| | that the maleic anhydride moiety constitutes about 1.35 wt. % of the |
| | material. |
| HDPE-5 | A copolymer of ethylene and dimethyl-7-octen-1-ylsilane having a |
| | molecular weight (Mn) of 12 kDa, polydispersity index of 2.45 and |
| | containing about 2.5 wt. % silane monomer. |
| Pt-Solution-1 | A solution of Pt(0) ligated to 1,3-divinyl-1,1,3,3- |
| | tetramethyldisiloxane, containing 0.5 wt. % Pt, and 5.5 wt. % |
| | ligand in a α,ω-vinyl-terminated polydimethylsiloxane. |
| Silicone | α,ω-dimethylvinylsiloxy-terminated random copolymer of |
| Fluid-1 | polydimethylsiloxane and polymethylvinylsiloxane with a total vinyl |
| | content of about 1.1 wt. % and a zero shear viscosity of about 400 |
| | mPa-s at 25° C. and a polydispersity index of about 2. |
| Silicone | 99 wt. % tetramethyltetravinyltetracyclosiloxane with |
| Fluid-2 | 0.5 wt. % each of pentamethylpentavinylcyclopentasiloxane and |
| | trimethyltrivinylcyclotrisiloxane. |
| Silicone | α,ω-dimethylsilanol-terminated oligomeric polydimethylsiloxane |
| Fluid-3 | having a viscosity of approximately 41 mPa-s at 25° C., average |
| | hydroxyl content of approximately 3.0 wt. % OH, and polydispersity |
| | index of about 1.6. |
| Silicone | Branched oligomeric trimethylsilyl-terminated polydimethylsiloxane- |
| Fluid-4 | polyhydridomethylsiloxanecopolymer with an average of one T |
| | branched unit per chain with viscosity of 15 mPa-s at 25° C. and |
| | including 0.84 wt. % H in the form of SiH. |
| Inhibitor Mix | A 3 wt. % solution of 1-ethynylcyclohexanol in Silicone Fluid-1. |
| Masterbatch-1 | Dispersion of 64 wt. % of dimethylvinylsiloxy-terminated |
| | polydimethylsiloxane having a viscosity of about 55,000 mPa-s at |
| | 25° C. with a total vinyl content of 0.088 wt. % and 36 wt. % of |
| | dimethylvinylated and trimethylated treated fumed silica. |

### General Procedure 1: Silicone-Polyolefin Compatibilization

Compatibilization was performed in a polymer mixer (Thermo Haake Polylab 50 cc mixer). The instrument was heated to the specified temperature and the silicone (PDMS) and polyolefin (HDPE/LLDPE) were added and allowed to mix for 2 minutes at 100 rpm. At this point, Pt-Solution-1 was added to the polymer blend, and compatibilization was allowed to proceed for the specified time at 100 rpm at temperature. Small (i.e., diameter predominantly below 10 μm) polyolefin domain size was used as an indicator of effective compatibilization. Domain size was determined by optical microscopy at 256× and 640× magnification.

### Examples 1-5 and Comparative Example 1

Various flowable silicone-polyolefin hybrid compositions were prepared according to General Procedure 1 above to give Examples 1-5 and Comparative Example 1. The particular components, parameters, and properties associated with Examples 1-5 and Comparative Example 1 are set forth in the following sections.

Example 1: HDPE-1 (7.6 g) was combined with Vinyl PDMS-1 (30.4 g) at 140° C. in accordance with the general procedure outlined above. Compatibilization was induced through addition of Pt (10 ppm Pt, Pt-Solution-1). The reaction was allowed to proceed for 10 minutes, and the blend was then removed from the mixer. The compatibilized material was obtained as a colorless, smooth, opaque suspension, having polyolefin domains with sizes predominantly below 10 μm.

Example 2: HDPE-2 (7.6 g) was combined with Vinyl PDMS-1 (30.4 g) at 120° C. in accordance with the general procedure outlined above. Compatibilization was induced through addition of Pt (10 ppm Pt, Pt-Solution-1). The reaction was allowed to proceed for 10 minutes, and the blend was then removed from the mixer. The compatibilized material was obtained as a colorless, smooth, opaque suspension, having polyolefin domains with sizes predominantly below 10 μm.

Example 3: HDPE-1 (3.8 g) was combined with Vinyl PDMS-1 (34.2 g) at 120° C. in accordance with the general procedure outlined above. Compatibilization was induced through addition of Pt (10 ppm Pt, Pt-Solution-1). The reaction was allowed to proceed for 10 minutes, and the blend was then removed from the mixer. The compatibilized material was obtained as a colorless, smooth, opaque suspension, having polyolefin domains with sizes predominantly below 20 μm.

Example 4: HDPE-1 (11.4 g) was combined with Vinyl PDMS-1 (26.6 g) at 120° C. in accordance with the general procedure outlined above. Compatibilization was induced through addition of Pt (10 ppm Pt, Pt-Solution-1). The reaction was allowed to proceed for 10 minutes, and the blend was then removed from the mixer. The compatibilized material was obtained as a colorless, smooth, opaque suspension, having polyolefin domains with sizes predominantly below 10 μm.

Example 5: HDPE-1 (15.2 g) was combined with Vinyl PDMS-1 (22.8 g) at 120° C. in accordance with the general procedure outlined above. Compatibilization was induced through addition of Pt (10 ppm Pt, Pt-Solution-1). The reaction was allowed to proceed for 10 minutes, and the blend was then removed from the mixer. The compatibilized material was obtained as a colorless, smooth, opaque suspension, having polyolefin domains with sizes predominantly below 10 μm.

Comparative Example 1: HDPE-2 (7.6 g) was combined with Vinyl PDMS-1 (30.4 g) at 120° C. in accordance with the general procedure outlined above. The polymers were allowed to blend in the absence of catalyst for 10 minutes, and the blend was removed from the mixer. The obtained material was an unstable suspension which phase separated upon standing. The polyolefin domains of the suspension were predominantly above 10 μm, with domains as large as 50 μm observed.

### General Procedure 2: Formation of Hybrid Liquid Silicone Rubber (LSR) Compositions

Formulation of Hybrid Blend: A HDPE Polyolefin and Masterbatch-1 were combined in a polymer mixer (Thermo Haake Polylab 50 cc mixer) at 50 rpm and premixed 2 minutes at an elevated temperature. A compatibilizing agent was then added to the combination, which was mixed for 5 minutes before and then removed from the mixer to give a Hybrid Blend.

Formulation of Part A: The Hybrid Blend (10.96 g) formed above was combined with Vinyl PDMS-1 (0.53 g), Silicone Fluid-1 (0.38 g), Silicone Fluid-2 (0.014 g), Silicone Fluid-3 (0.093 g), and Pt-Solution-1 (0.033 g) in a plastic cup and mixed until homogeneous to give Part A component of a curable composition.

Formulation of Part B: Masterbatch-1 (8.8 g), Vinyl PDMS-1 (0.53 g), Silicone Fluid-1 (0.14 g), Silicone Fluid-3 (0.095 g), Silicone Fluid-4 (0.23 g), and Inhibitor Mix (0.25 g) were combined in a plastic cup and mixed until homogeneous to give Part B component of a curable composition.

Mixing of Hybrid LSR & Cure: Part A and Part B formed above were combined and mixed until homogeneous to form a curable composition, obtained as an opaque colorless mixture. The curable composition was spread in a mold measuring 51×51×2 mm and cured at 200° C. for 2 minutes to give a cured product.

### Examples 6-7 and Comparative Examples 2-3

Various curable compositions and cured products were prepared according to General Procedure 2 above to give Examples 6-7 and Comparative Examples 2-3. The particular components, parameters, and properties associated with Examples 6-7 and Comparative Examples 2-3 are set forth in the following sections and Tables 2-4 further below. Unless indicated otherwise, each example was carried out in duplicate and material properties reported as an average of the observed values.

Example 6: The initial hybrid blend was formed by mixing HDPE-3 (7.6 g) and Masterbatch-1 (30.4 g) for 2 min at 120° C. Compatibilization was induced via addition of Pt-Solution-1 (10 ppm Pt), followed by mixing for 5 min at 120° C. The Part A composition exhibited a viscosity of 855.9 Pa-s at 10 s⁻¹ (25° C.). The formation of the LSR was carried out as indicated above. The uncured LSR exhibited a viscosity of 337.3 Pa-s at 10 s⁻¹ (25° C.). Electron microscopy showed the presence of PE domains with diameters predominantly below 1 μm and a mean domain size of 0.6 μm.

Example 7: The initial hybrid blend was formed by mixing HDPE-4 (8.45 g) and Masterbatch-1 (35.6 g) for 2 min at 180° C. Compatibilization was induced via addition of Amino PDMS-1 (0.44 g), followed by mixing for 5 min at 180° C. The formation of the LSR was carried out as indicated above. Electron microscopy showed the presence of PE domains with diameters predominantly below 1 μm and a mean domain size of 1.18 μm.

Comparative Example 3: The initial hybrid blend was formed by mixing HDPE-5 (7.6 g) and Masterbatch-1 (30.4 g) for 7 min. The Part A composition exhibited a viscosity of 455.6 Pa-s at 10 s⁻¹ (25° C.). The formation of the LSR was carried out as above. The obtained uncured LSR has a viscosity of 330.0 Pa-s at 10 s-1 (25° C.) ° C. Electron microscopy showed the presence of PE domains with diameters predominantly above 1 μm.

Comparative Example 4: The initial hybrid blend was formed by mixing HDPE-4 (8.45 g) and Masterbatch-1 (36.0 g) for 7 min at 180° C. The formation of the LSR was carried out as indicated above. Electron microscopy showed the presence of PE domains with a mean domain size of 1.18 μm.

TABLE 2
Hybrid Blends of Examples 6-7 & Comparative Examples 3-4

| Example: | | 6 | 7 | Comp 3 | Comp 4 |
|---|---|---|---|---|---|
| Silicone Base | Mass [g] | 30.40 | 35.60 | 30.40 | 36.00 |
| MB52 | wt % | 80.00 | 80.02 | 80.00 | 80.99 |
| Polyethylene | PE Type | HDPE-3 | HDPE-4 | HDPE-5 | HDPE-4 |
| | Mass [g] | 7.60 | 8.45 | 7.60 | 8.45 |
| | wt % | 20.00 | 18.99 | 20.00 | 19.01 |
| Compatibilizer | Type | Pt-Solution-1 | Amino PDMS-1 | — | — |
| | Mass [g] | — | 0.44 | — | — |
| | wt % | 10 ppm Pt | 0.99 | — | — |
| Mixing Temp. | [° C.] | 120 | 180 | 120 | 180 |

TABLE 3
Part A Components of Examples 6-7 & Comparative Examples 3-4

| Example: | | 6 | 7 | Comp 3 | Comp 4 |
|---|---|---|---|---|---|
| Hybrid | Mass [g] | 10.96 | 10.96 | 10.96 | 10.96 |
| | wt % | 91.26 | 91.26 | 91.26 | 91.26 |
| Vinyl PDMS-1 | Mass [g] | 0.53 | 0.53 | 0.53 | 0.53 |
| | wt % | 4.41 | 4.41 | 4.41 | 4.41 |
| Silicone Fluid-1 | Mass [g] | 0.38 | 0.38 | 0.38 | 0.38 |
| | wt % | 3.16 | 3.16 | 3.16 | 3.16 |
| Silicone Fluid-2 | Mass [g] | 0.01 | 0.01 | 0.01 | 0.01 |
| | wt % | 0.12 | 0.12 | 0.12 | 0.12 |
| Silicone Fluid-3 | Mass [g] | 0.09 | 0.09 | 0.09 | 0.09 |
| | wt % | 0.77 | 0.77 | 0.77 | 0.77 |
| Pt-Solution-1 | Mass [g] | 0.03 | 0.03 | 0.03 | 0.03 |
| | wt % | 0.27 | 0.27 | 0.27 | 0.27 |
| Total | Mass [g] | 12.01 | 12.01 | 12.01 | 12.01 |
| | wt % | 100.00 | 100.00 | 100.00 | 100.00 |

TABLE 4
Part B Components of Examples 6-7 & Comparative Examples 3-4

| Example: | | 6 | 7 | Comp 3 | Comp 4 |
|---|---|---|---|---|---|
| Masterbatch-1 | Mass [g] | 8.80 | 8.80 | 8.80 | 8.80 |
| | wt % | 87.61 | 87.61 | 87.61 | 87.61 |
| Vinyl PDMS-1 | Mass [g] | 0.53 | 0.53 | 0.53 | 0.53 |
| | wt % | 5.28 | 5.28 | 5.28 | 5.28 |
| Silicone Fluid-1 | Mass [g] | 0.14 | 0.14 | 0.14 | 0.14 |
| | wt % | 1.39 | 1.39 | 1.39 | 1.39 |
| Silicone Fluid-3 | Mass [g] | 0.10 | 0.10 | 0.10 | 0.10 |
| | wt % | 0.95 | 0.95 | 0.95 | 0.95 |
| Silicone Fluid-4 | Mass [g] | 0.23 | 0.23 | 0.23 | 0.23 |
| | wt % | 2.29 | 2.29 | 2.29 | 2.29 |
| Inhibitor Mix | Mass [g] | 0.25 | 0.25 | 0.25 | 0.25 |
| | wt % | 2.49 | 2.49 | 2.49 | 2.49 |
| Total | Mass [g] | 10.05 | 10.05 | 10.05 | 10.05 |
| | wt % | 100.00 | 100.00 | 100.00 | 100.00 |
| Viscosity | Pa-s | 394.7 | 394.7 | 394.7 | 394.7 |

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

1. A flowable silicone-polyolefin composition, comprising:
(A) a polysiloxane comprising an average of at least one functional group X per molecule; and
(B) a functionalized polyolefin dispersed in the polysiloxane (A), the functionalized polyolefin (B) comprising an average of at least one functional group Y per molecule, where the functional group Y of the functionalized polyolefin (B) is reactable with the functional group X of the polysiloxane (A) to form a bond therebetween.

2. The flowable silicone-polyolefin composition of claim 1, wherein the polysiloxane (A) has the following average unit formula:
[XₘR¹₃₋ₘSiO_{1/2}]ₐ[XₙR¹₂₋ₙSiO_{2/2}]_{b},
where X is the functional group defined above, each R¹ is an independently selected hydrocarbyl group, subscript m is independently 1 or 0 in each moiety indicated by subscript a, subscript n is independently 1 or 0 in each moiety indicated by subscript b, and subscripts a and b are each mole fractions such that a+b=1, with the provisos that 0<a<1, 0<b<1, and the polysiloxane (A) comprises at least one functional group X.

3. The flowable silicone-polyolefin composition of claim 1, wherein: (i) the polysiloxane (A) comprises an average of at least two functional groups X per molecule; (ii) each functional group X is a silicon-bonded olefinically-unsaturated group or an aminoalkyl group; (iii) each functional group X is terminal; or (iv) any combination of (i)-(iii).

4. The flowable silicone-polyolefin composition of claim 1, wherein the polysiloxane (A): (i) exhibits a viscosity of at least 1000 cP at 25° C.; (ii) has a degree of polymerization (DP) of from 50 to 1200; (iii) has a polydispersity index (PDI) of from 1.5 to 2.5; (iv) is present in the flowable silicone-polyolefin composition in an amount of from 60 to 99 wt. %, based on the combined weight of components (A) and (B); or (v) any combination of (i)-(iv).

5. The flowable silicone-polyolefin composition of claim 1, wherein: (i) the functionalized polyolefin (B) comprises a functionalized polyethylene (PE), polypropylene (PP), or polyethylene-alpha olefin copolymer; (ii) the functionalized polyolefin (B) comprises an average of at least two functional groups Y per molecule; (iii) each functional group Y comprises a hydridosilyl group or an anhydride group; or (iv) any combination of (i)-(iii).

6. The flowable silicone-polyolefin composition of claim 1, wherein the functionalized polyolefin (B): (i) has a polydispersity index (PDI) of from 2 to 10; (ii) is functionalized with from 0.1 to 5 wt. % of functional moieties comprising functional group Y, based on the total weight of the functionalized polyolefin (B); (iii) is present in the flowable silicone-polyolefin composition in an amount of from 1 to 40 wt. %, based on the combined weight of components (A) and (B); or (iv) any combination of (i)-(iii).

7. The flowable silicone-polyolefin composition of claim 1, further comprising (C) a catalyst adapted to facilitate a coupling reaction between the functional group X of the polysiloxane (A) and functional group Y of the functionalized polyolefin (B).

8. The flowable silicone-polyolefin composition of claim 7, wherein the catalyst (C): (i) is selected from hydrosilylation catalysts, condensation catalysts, and combinations thereof; (ii) is present in the flowable silicone-polyolefin composition in an amount of from 1 to 100 ppm; or (iii) both (i) and (ii).

9. The flowable silicone-polyolefin composition of claim 7, wherein each functional group X of the polysiloxane (A) is a vinyl group, wherein each functional group Y of the functionalized polyolefin (B) comprises a hydridosilyl group, and wherein the catalyst (C) is a hydrosilylation catalyst.

10. The flowable silicone-polyolefin composition of claim 1, wherein the flowable silicone-polyolefin composition: (i) is free from a carrier vehicle; (ii) is free from a reaction catalyst or promotor; (iii) further comprises a reaction inhibitor; or (iv) any combination of (i)-(iii).

11. The flowable silicone-polyolefin composition of claim 1, comprising a number average polyolefin domain size of less than 20 μm in diameter.

12. A method of preparing the flowable silicone-polyolefin composition of claim 1, said method comprising:
dispersing the functionalized polyolefin (B) in the polysiloxane (A), thereby preparing the flowable silicone-polyolefin composition.

13. The method of claim 12, wherein dispersing the functionalized polyolefin (B) in the polysiloxane (A): (i) comprises melt blending or extruding components (A) and (B) at a temperature of from 100 to 200° C.; (ii) comprises reactively coupling the polysiloxane (A) and the functionalized polyolefin (B); (iii) is carried out in the presence of the catalyst (C); (iv) is carried out under substantially solvent-free conditions; or (v) any combination of (i)-(iv).

14. A curable composition, comprising the flowable silicone-polyolefin composition of claim 1 and: (i) a cure catalyst; (ii) a filler; (iii) a cross-linker; or (iv) any combination of (i)-(iii).

15. The curable composition of claim 14, wherein: (i) the curable composition comprises the cure catalyst, and where the cure catalyst is a hydrosilylation catalyst (ii) the curable composition comprises the filler, and where the filler is a silica; (iii) the curable composition comprises the cross-linker, and where the cross-linker comprises a silicone fluid comprising an average of at least two hydrosilylatable groups per molecule; (iv) the curable composition is substantially free from a carrier vehicle; or (v) any combination of (i)-(iv).

16. The curable composition of claim 14, further defined as an uncured hybrid liquid silicone rubber and comprising a number average polyolefin domain size less than 1.5 μm in diameter.

17. A cured product of the curable composition of claim 14.

18. A method of preparing a cured product, said method comprising curing the curable composition of claim 14, thereby preparing the cured product.

19. The cured product of claim 17, further defined as a cured hybrid liquid silicone rubber.
